(19) United States
(12) Patent Application Publication
(10) Pub. No.: US 2023/0183975 A1
(43) Pub. Date: Jun. 15, 2023

(54) INTEGRATED COMPONENTS AND SERVICES IN COMPOSITE PANELIZED BUILDING SYSTEM AND METHOD

(71) Applicant: DECOi Inc., Charlestown, MA (US)

(72) Inventor: Mark Goulthorpe, Charlestown, MA (US)

(21) Appl. No.: 18/080,693

(22) Filed: Dec. 13, 2022

Related U.S. Application Data
(60) Provisional application No. 63/289,036, filed on Dec. 13, 2021.
(60) Provisional application No. 63/289,029, filed on Dec. 13, 2021.
(60) Provisional application No. 63/289,052, filed on Dec. 13, 2021.

(51) Int. Cl. E04C 2/52; E04C 2/24

(52) U.S. Cl. CPC E04C 2/525; E04C 2/243; E04C 2002/001

(57) ABSTRACT

Systems and methods are described herein for a composite building panel for use in a panelized structure. In some aspects, a composite building panel may include: a core defining a channel formed via subtractive manufacturing; a utility conduit placed or formed in and bonded to the channel and enclosed by the core, where the utility conduit exits the core along a first mating edge of the core; and first and second skin elements bonded to the core to form a layered structure. In some cases, the layered structure may also include a reinforced block coupled to at least the first fiber-reinforced skin element and defining part of the first mating edge, where the reinforced block defines a first portion of the first mating edge for mating with another composite building panel of the panelized structure.

### CROSS REFERENCE TO THE RELATED APPLICATIONS

This application claims priority to U.S. Provisional Patent Application No. 63/289,029, filed Dec. 13, 2021, entitled “COMPOSITE PANELIZED BUILDING SYSTEM AND METHOD”, U.S. Provisional Patent Application No. 63/289,036, filed Dec. 13, 2021, entitled “INTEGRATED COMPONENTS AND SERVICES IN COMPOSITE PANELIZED BUILDING SYSTEM AND METHOD”, and U.S. Provisional Patent Application No. 63/289,052, filed Dec. 13, 2021, entitled “SUB-DERMAL JOINTING FOR COMPOSITE PANELIZED BUILDING SYSTEM AND METHOD”, which are hereby incorporated herein by reference in their entirety and for all purposes.

### BACKGROUND

The predominant building paradigm in various industrialized markets involves the assemblage of mass-produced components/fixtures/fittings: buildings are comprised of many thousands, or tens of thousands of industrial components mechanically joined together. Building functionality generally involves discrete building systems operating in isolation, such as heating being separated from cooling, or electrical being distinct from heating. But also, simpler building elements such as the structure being separated from cladding, or a window frame being distinct from a wall or window. The separatism of materials and systems typifies the late-industrial conception of building, and is mirrored in distinct trades and even consultants, such that the building sector is one of notable many-part complexity.

While this multi-material, multi-part logic of the construction sector seemingly allows for efficiency and economy in manufacture and operation, with mass production of simple elements, in fact it results in a high level of redundancy and inefficiency in the bringing-together of so many parts and the requisite labor such multiplicity involves. The manufacturing sector, by contrast, by embracing new materials such as unitary-material plastics and composites and new computational design and fabrication methods (CAD-CAM), has doubled productivity over the past 30 years, where the building sector has maintained a multi-component logic (which limits digital design/manufacture), so decreasing its productivity over the same period. The labor/logistical burden is expressed in the fact that in buildings in the EU and the USA, the material cost is only 15%, with 85% involved in the complex orchestration of thousands of discrete parts into buildings. This multi-part assembly also tends to offer poor energy efficiency, poor life cycle analysis, poor longevity as well as high time and cost burden.

### BRIEF DESCRIPTION OF THE DRAWINGS

Various techniques will be described with reference to the drawings, in which:

FIG. 1 illustrates an example 5-panel planar structural composite building corner with integrated sub-dermal electrical, plumbing, and heating conduits, window and door frames, and panel joints, in accordance with at least one embodiment;

FIGS. 2-3 illustrate example views of a 3 planar fiber-reinforced structural panels joined to form the corner of a building with integrated functional elements, in accordance with at least one embodiment;

FIG. 4 illustrates an example of a building panel with excavated and fully encapsulated electrical conduits for an electrical box, in accordance with at least one embodiment;

FIGS. 5A-5C illustrate example views of a building panel with excavated and fully encapsulated electrical conduits for a light installation, in accordance with at least one embodiment;

FIGS. 6A-6B illustrate an example views of a composite structural wall panel showing an excavated cavity for a junction box with encapsulated sub-dermal electrical conduits ready for wiring, in accordance with at least one embodiment;

FIG. 7 illustrates an example diagram of multiple manufacturing stages to produce a small floor panel with sub-dermal heating water piping & electrical conduits, in accordance with at least one embodiment;

FIGS. 8A-8J illustrate example stages in an example process to manufacture a small floor panel with sub-dermal heating water piping & electrical conduits, in accordance with at least one embodiment;

FIG. 9 illustrates an example process for manufacture a building panel, such as the building panel illustrated in FIGS. 8A-8J, in accordance with at least one embodiment;

FIG. 10 illustrates an example diagram of multiple manufacturing stages to produce a building panel with sub-dermal heating water piping & electrical conduits, in accordance with at least one embodiment;

FIGS. 11A-11K illustrate example stages in an example process to manufacture a building panel with sub-dermal heating water piping & electrical conduits, in accordance with at least one embodiment; and

FIG. 12 illustrates a finished example of a building panel, such as manufactured according to stages 11A-11J, in accordance with at least one embodiment.

### DETAILED DESCRIPTION

The emerging paradigm of fiber-reinforced composite materials tends to vastly reduce the need for discrete components as they offer poly-functionality in their capacity to be formed freely and to offer variable structural property as needed. For example, in cases where a window frame or a door frame are typically inserted into a wall assembly as a necessary intermediary assembly for the actual glazed window element or door, fiber-reinforced composites allow for a fully-integrated edge to be manufactured into the composite structural panel. Similarly, electrical systems and plumbing systems typically involve the fabrication of discrete systems (pipes and joints) that need to be bored through building elements on site such as studs, sheathing, insulation, etc., where with composites such components and systems can be fused into a large-format poly-functional building element, similar to a whole fuselage of an aircraft with all elements fully integrated.

The reduction of parts offers not only economy by reducing assembly complexity and labor, but also avoids joints that are typically points of vulnerability in building assembly, prone to rot, rust, leakage, etc. Energy efficiency in buildings is also largely a factor of the air-tightness of joints, so fusing elements such as window frames can offer significant advantage to the overall performance of buildings. In addition, the ability to integrate conduits and chases within any given composite panel can minimizes site labor and can permit automated or quasi-automated manufacture in a composite fabrication process. Minimizing or eliminating the on-site establishment of conduit lines and chases can greatly reduce labor and costs in installation, and it can allow pre-wiring and pre-plumbing that further reduces trades, labor and time needed on a building site.

One aspect of integrated components and services in such composite panel building systems as discussed herein can be to deploy minimal material spatially in a given location to attain a given functionality needed for code-compliant or other required or desired functionality, be it structural, acoustical, thermal, fire-retardancy or any other functionality. This can reduce the use of materials and can potentially reduce the embodied mass, complexity and/or environmental footprint of the base building envelope. By integrating all components or services in a few-component composite building system, the described techniques can reduce labor, time and complexity of building quite dramatically, which can offer time, labor and logistical economy.

The present disclosure, in some aspects, includes buildings wholly or in part comprised of fiber-reinforced thin-skin composite structural or non-structural panels, where some or all edges, penetrations, recesses and inserts, whether for functional or other needs or purposes, may be formed by a dense sub-dermal material fully integrated (bonded) into the composite panel. Effectively, various embodiments can allow for some or all recessed details in a building envelope—for electrical, lighting, heating, attachments, decoration and any other technical or aesthetic elements—to be formed integrally with the composite structural panel. In other words, various embodiments include a building method where large-scale composite panels can have edges, penetrations, recesses, pockets, cavities, attachments, and the like, integrated materially into base composite panel, so that functional details can be formed within the base material substrate of a large structural or non-structural building element such as a wall.

In a typical house, there can be many elements attached to the walls and ceilings such as lights, light switches, cable outlets, smoke detectors, power outlets, brackets for shelves, towel rails, hooks, toilet roll holders, wall-mount or floor mount toilets and basins, vents, flat-screen televisions, speakers, and many other such items. In various embodiments, some or all such elements can require a structural fixing to give them adequate strength, which in a thin-skin structural panel can include a sub-dermal or supra-dermal mass to permit a screw or other fixing to bed into material that can be more solid than a low-density core. Here, various embodiments include a sub-dermal dense filler material that is cut, drilled, milled or routed to provide a precise pre-fabricated fixing point (e.g., fully) integrated as part of the base building element.

In various embodiments, many such fixing points can require electrical or plumbing connections, often requiring a protected cavity such as a junction box or a transformer box, which in some examples can be provided by precise cavitation of a sub-dermal mass. The cavity or recess formed in the sub-dermal mass can provide a recess that can allow for such fittings to be accurately inserted and/or attached, or it can substitute for that element to minimize components, such as for example a junction box, now being formed directly and fully integrated into the composite panel. One practical benefit of having precise cavitation for fixtures, fittings, components, etc. can be that cover plates or face plates can now be fitted to be absolutely flush with the wall, ceiling, floor or element surface, where typically they cover-over a rough hole cut in gypsum board or the like. In some cases, door handles, draw pulls and other recesses can be milled into the sub-dermal dense filler material in the fiber-reinforced structural composite panels in various embodiments, which may obviate the need for external attachments, which can minimize cost and labor.

The integration of some or all recessed details into the (e.g., fiber-reinforced) composite panels can be enabled in some embodiments by a manufacturing logic of subtractive and additive manufacture, whereby a dense reinforced material mass can be introduced into the panel locally to permit the edge, recess, pocket, cavity or attachment to be formed by excavation from its sub-dermal mass. The overall result in some examples can be a building comprised wholly or in part from fiber-reinforced structural or non-structural composite panels, where some or all necessary or desired details are formed in the panels, which in some embodiments can be used to attain a highly integrated and poly-functional building element, which in some examples can require little or no further modification on a building site except attachment of electrical or heating systems (e.g., wires between panels, plumbing fixtures between panels, etc.).

The panels can comprise, consist essentially of or consist of thin structural skins bonded continuously to both sides of a sub-dermal lightweight core block so as to attain a structural composite panel. The skins can be formed by combination of a structural fiber and a matrix such as a polymeric resin or other material, where a well-consolidated matrix/fiber composite can be formed by thermoplastic, pre-preg, wet-preg, infusion, RTM or any other suitable method. These fiber-reinforced skins can be attached by continuous bonding to opposite sides of a core material panel that in some examples can be a low density material such as a polymeric foam or other suitable material. The core material can act as a substrate to the skins, holding them in place, allowing the composite skin-core-skin panel to act as a structural element. The skins can be bonded continuously to the core panel either adhesively or by the matrix material itself, and the two skins can act like the flanges of a beam, carrying tension or compression, with the core acting like a large spatialized “web” in some embodiments that can carry shear but serves chiefly to hold the planar skins spatially in place a given distance from one another.

The core material can offer another function due to its low density and thickness in some embodiments, which may allow it to provide thermal insulation to the composite panel and to a building formed as an assembly of such panels. This can be desirable in some embodiments as energy efficiency and environmental footprint become significant factors in building performance as global society faces climate change, allowing such composite panel buildings to be energy efficient in various examples. Continuity of the core material, (which is not interrupted by studs or other thermal bridging elements in some examples), can make such fiber reinforced structural composite panels particularly effective as an insulating building panel or building envelope assembly in some embodiments.

A further functionality can be offered by a continuous core material, which can be to serve to block sound transmission, including in embodiments where there are no bridging elements such as studs or joists, since the skin-core-skin composite panel itself can act as a structural element. Typically, sound can be transmitted most effectively through gaps in materials, so a continuous skin-core-skin panel of some embodiments can eliminate a large part of such sound transmission. But low density materials such as those typically used in composite structural panels (for example polymeric foams or balsa wood) may not be especially effective against transmission of certain frequencies of sound in some examples, and for this reason in various embodiments the core may be built up in layers of material that each attain a different sound transmission characteristic such that the composite panel functions acoustically as necessary or desired in a given location in the building or for other suitable purpose. So, for example, a sub-dermal carbon foam layer added to a polymeric foam core block may offer greater acoustical blocking to the overall composite panel in some examples.

However, the core material(s), being low density, can be vulnerable to weather, fire, abrasion, insects, etc. in various embodiment. Where there is a fiber-reinforced skin, fully inundated with a matrix to form an impermeable structural membrane, this may provide adequate protection against these risks in some embodiments. However, wherever a fiber-reinforced skin does not cover the low density core material(s), such as at any edge of the structural reinforced skin, including any penetration points for pipes, conduits, electrical or plumbing outlets, recesses, cutouts, or for other functional needs, then the vulnerable core material can be exposed to such risk in various examples. At these points a barrier can be created by sub-dermal infill of a dense reinforced material mass that can be (e.g., fully) integrated in the composite structural panel element. This can mean that in some embodiments it is bonded to any or all of the adjacent materials to become an integral part of the composite panel at points where there is no fiber-reinforced skin.

In various embodiments of a skin-core-skin composite panel, the core material can be effectively ubiquitous: for example, everywhere there is a fiber-reinforced structural skin, it may be bonded to a sub-dermal core across the entire extent of the skins' inner surfaces. There may be no voids or cavities in the insulating core material in various embodiments as there would be in a stud wall, as in some examples the skin needs bonding over a portion or the totality of its surface for it to perform structurally and not buckle or peel off the core under structural or other loading.

The core material may be made of one, two or more layers that are bonded into a multi-material substrate that can have different properties according to the need or as desired in a given location of the building or for other suitable purpose. So, in some examples, an acoustically absorptive material, or a high fire retardancy material can be added as a relatively thin layer bonded to the generally-thicker, thermally insulating, generally low-density core.

This ubiquity of core material and the uniformity and cohesiveness of its material layers in various embodiments, can allow for it to be easily machined by endmills, discs, routers, or any other tool: indeed, in some examples, the cores can be selected for their ability to be machined by such tools, allowing that they can be precisely manufactured by excavation or cutting by such means. This in various examples can allow cavities to be excavated from the material mass of the core, which may allow a dense protective or functional material to be later be introduced into the cavity according to functional need or desire at that location in the building or for other suitable purpose.

At some or all locations that can be edges of the fiber-reinforced skin, whether at panel edges or at points where in various embodiments there can be a penetration, recess, cavity, cutout or other interruption of the fiber-reinforced skin for functional or aesthetic reasons, a cavity can be formed prior such that a more dense, less vulnerable, higher-performance material can be introduced into the cavity in some examples to provide protection to the core (e.g., against fire, insects, weather, abrasion, wear and tear or other functional needs or desire or for other suitable purpose) and support to other functional elements. In other words, in some embodiments, any and all (or at least some) functional elements needed or desired in a given building panel can be created by cavitation of a core and then deployment of a dense material (e.g., just-as-needed), which in some examples can establish an augmented and appropriate functionality as required or desired in that specific location or for other suitable purpose.

Thought of differently, in various embodiments dense material can be deployed just-as-needed in a continuous volume of low-density insulating core, quantitatively and qualitatively sufficient to the given function required in that specific location, offering a minimal and elegant use of material to attain building functionality. In various embodiments, such technology no longer relies upon (or no longer substantially relies upon) a series of industrially-fabricated components that are mechanically joined to provide a fixing point such as an electrical junction box. Instead, in various embodiments, some or all such fixing points and/or cavities can be formed by integration of suitable material into the base composite panel, which may offer a highly integrated functionality for various suitable building functions.

The (e.g., dense) infill material of some embodiments can have varying properties as needed in the given location, whether as a solid insert or a liquid that solidifies in place. Varying properties can include the degree of fire retardancy, structural capacity, resilience, resistance to UV light, or any other functionality needed or desired in that specific location of the building or in that specific region per building or other performance codes, or for other suitable purpose. Deployed as a series of solid material elements in some embodiments, the dense protective material inserted into the cavities in the core may be a different material in different locations according to the need or as desired in that specific location or for other suitable purpose. In various examples, solid material inserts can be precisely cut to shape prior to insertion. When deployed as a liquid or semi-solid material that solidifies in some embodiments, the dense protective material inserted into the cavities in the core may be a different material in different locations according to the need or as desired in that specific location or for other suitable purpose. And it can allow in various examples that the mixture of such liquid or semi-solid can be varied as the cavities are filled, which in some examples can allow continuously changing or abruptly-changing property.

In one example the liquid or semi-solid infill material can have a varying quantity of structural reinforcing fibers or beads (in glass or other material) so altering the structural properties it offers. In another example the liquid or semi-liquid can have a varying quantity of fire retarding material (such as aluminum tri-hydrate or other material) so altering the fire retarding properties it offers. Other examples can alter the physical and/or chemical characteristics to suit the specific needs or as desired in that location or for other suitable purposes, so another example can have both structural and fire enhanced infill material.

The machined cavities in the low-density core may have orthogonal or sloped sides, which in some examples can aid in the insertion of protective filler material and/or to aid in the full filling and adhesion of the core to the filler material. The machined cavities may be any suitable depth or width, but some embodiments can require the cavity to be fully or substantially fully filled to re-establish a coherent, bonded core where there are no or substantially no voids in the multi-material composite panel except as needed or desired for conduits, chases and any other necessary or desired voids designed to maintain structural and any other performance or for any other suitable purpose.

In various embodiments, cavities in the low density core panel can act as a buffer or dam to permit solid, liquid or semi-solid materials such as pastes to be used to fill the cavity fully. In some examples it can be desirable for infill materials to attain full or substantially full adhesion to some or all adjoining faces and ultimately full or substantially full adhesion to the fiber reinforced skin when it is applied to the outer face of the multi-material panel. In various embodiments, it can be desirable for infill materials in the cavities in the low density core to fully fill or substantially fill the cavity such that the new outer surface is flush and co-planar with the low density core, which can allow that the fiber-reinforced skins can be bonded across the new multi-material outer surface. In one example the cavities can be over-filled slightly such that by sanding or fly-milling (or the like) of the outer surface, the multi-material panels can attain an absolutely or substantially flat aspect ready for bonding to the fiber-reinforced skin or for other suitable purpose. This can be desirable in various embodiments so there is no change or minimal change of level in the surface of the core panel that could translate to the outer aspect of the fiber-reinforced skin. If under-filled initially, in some embodiments the cavities can be topped-off with filler material to attain a desired flatness of the outer surface of the multi-material core.

Given the low-density and generally structurally weak nature of some embodiments of the low-density core material in the fiber-reinforced composite panels, in various examples it can be desirable for this barrier material that infills cavities to offer enough structural capacity and resilience to function as the typical analogous building elements would exhibit that it may be replacing. For example, if the infill material forms the end of a wall, it can be desirable for the infill material to perform in similar manners to a wall surface in a building, attaining fire and waterproofing as well as resiliency against typical impacts and wear and tear and the like. In another example, if the infill material will serve as a window frame, it can be desirable in various embodiments to allow the window itself to operate consistently and accurately as if it were a wood or aluminum frame as well as to resist weather and water and the like. In a further example, if the infill material functions to house an electrical outlet, then it can be desirable in various embodiments to attain sufficient pull-out strength to permit tight-fitting electrical sockets to be tugged on to dis-connect them, or sufficient compressive strength to permit them to be pushed into the outlet or the like.

Evidently in an actual building there can be many functional needs to be satisfied, so these few examples are only to illustrate a few specific cases and should therefore not be construed as being limiting: the composition and properties of the infill material and the size and shape of cavity that it fills can together offer a very broad range of possible functional uses in further embodiments that are within the scope and spirit of the present disclosure. The descried construction logic of infill can serve many different functional needs in buildings.

In various embodiments, it can be desirable for the barrier material to take on the form and function of the material it substitutes for, and in some examples, this can include a fiber-reinforced or bead-reinforced morphology, as these are some examples of how composites can attain strength and stiffness and resiliency. For example, the matrix can serve to maintain the spatial position of the fibers such that they function to their structural potential without spatial displacement. In one example, the inserted material can be a reinforced solid board cut to fit the cavity and adhesively bonded on some or all faces to the substrate core. In another example, the inserted or infill material can be a glass fiber- or glass bead-reinforced liquid or semi-solid that solidifies to form a solid mass where the liquid or semi-solid itself bonds to the substrate core. In another example, the infill material can be a matrix-filled carbon foam, where the glassified carbon itself can reinforce the matrix, which may be a resin in some embodiments. In these examples, any suitable fiber-and-matrix structural composite material can be used and the specific composite can be determined by the functional needs in a given location or by building code or other requirements or for other suitable purpose.

Where the infill material is solid, in various embodiments it can be shaped to allow for a thin adhesive layer to co-join it to some or all sides of the cavity in the low-density core material and/or to fit snugly when pressure is applied to permit effective bonding to occur.

As used herein, a semi-solid may refer to a paste, whereby the paste may be comprised of various materials, selected for specific performance attributes, including fire retardancy, water proofing, insulation properties, adhesion to different surfaces and different materials, and so on. As also described herein, any type of material, even those different than composites may be used to construct and form the various panelized building elements described herein, including various different aspects of panels, jointing elements, and so on, to a similar effect, including various metals, rubber, different type of plastic, organic material, and so on. The adhesives or gaskets used for these various materials may be selected to accommodate attributes of these materials.

In various examples, the paste or infill material may be selected for a specific purpose, such as to form a subdermal edge, form or bond to piping or conduit for electrical wiring, liquid transport, air transport, and so on. In yest some instances, as used herein, conduit may include any type of conduit, including conduits for transporting liquids (e.g., water, or liquids used in heating and cooling systems, and/or may transport heated or cooled air, for a similar purpose.

### Examples of Mitigating Shrinkage in Liquid or Semi-Solid Infill Materials

Where infill material is liquid or semi-solid, in various embodiments, it can be deployed into the cavities in the low density core material to completely or substantially fill them such that it bonds (e.g., fully) to some or all sides of all cavities as it cures and solidifies. Since liquids and semi- solids can reduce in volume as they solidify in some examples, there is risk in various examples that shrinkage can pull away from, split or distort the low-density core material. To mitigate this issue, in some embodiments, liquids and semi-liquids with low shrinkage can be preferred, and/or solid structural reinforcing material such as glass fiber or glass beads can be introduced into the filler material to mitigate shrinkage. The solid structural fibers or beads can act to limit any shrinkage because the matrix can bond to them and matrices such as polymeric resins can have high isotropic compressive capacity in various examples.

Where low-shrinkage liquid or semi-solid infill materials with shrinkage-limiting reinforcement still create problems, such as splitting, pulling-away-from or distorting the low-density core material, then short lengths of liquid or semi-liquid infill can be applied alternately or additionally in some embodiments. This may be thought of in some examples as a “dashed line” of liquid or semi-liquid where gaps are left between lengths of material deployed into the cavities in the low-density core. Once these first “dashes” have solidified independently, so the liquid or semi-solid filler can complete the gaps between them, minimizing any shrinkage and distortion by limiting the volume and length of a filled cavity. This dashed-line protocol can be done with two steps, or three, or any number as needed or desired to limit splitting, pulling-away from or distorting of the low-density core or for other suitable purpose.

To limit shrinkage, distortion, warping or splitting of the low-density core panels when the higher density liquid or semi-solid filler material solidifies in cavities, in some embodiments the core panel can be constrained in a planar manner. One example of this restraint can be by vacuum suction on one of the surfaces, or by applying a planar mass to the upper surface, or by any other suitable method. In other cases, to limit shrinkage, distortion, warping or splitting of the low-density core panels when the higher density liquid or semi-solid filler material solidifies in cavities, in various embodiments, it can be desirable to apply the filler to cavities on both sides of the core material simultaneously. In this arrangement, and in some examples, any shrinkage tends to be balanced on both sides as the filler material changes dimension equidistant from the neutral axis in the center of the panel.

In yet some cases, to limit shrinkage, distortion, warping or splitting of the low-density core panels when the higher density liquid or semi-liquid filler material solidifies in cavities, in various embodiments adhesion of a layer of a core material that has good compressive properties and/or good stiffness can be applied to one or both sides of the panel. The effect of this compressive plane on one or both faces of the low density core can be to resist structural compression from the filler material such that its shrinkage or warpage is minimized. In some other examples, to limit shrinkage, distortion, warping or splitting of the low-density core panels when the higher density liquid or semi-solid filler material solidifies in cavities, in various embodiments, any and all of the above strategies may be deployed individually, in concert, or in any suitable combination, each working to mitigate the common problem of shrinkage that occurs in most filler materials or for other suitable purpose, such as via polymeric milling paste or epoxy resins or any other suitable material.

### Example Trimming/Milling of Panels and Cavities

In some embodiments, the milled cavities can be slightly over-sized to permit infill materials to be trimmed back, allowing for a suitable tolerance in placing the overall panel for the milling or cutting operations. In various embodiments, it can be desirable for an area where the reinforced infill material is cut or milled to maintain coverage of some or all of the low-density core. Also, in various examples, it can be desirable for the edge of some or all structural skins to be (e.g., fully) bonded to the reinforced filler material. In other words, in various embodiments the low density core can be (e.g., fully) encapsulated or protected by the fiber-reinforced skins and/or by the dense reinforced infill material, and in some examples, except where it may be allowable to be exposed such as when protected by other elements such as joints that provide alternative cover.

In some embodiments, edges where fiber-reinforced panels connect to adjacent fiber-reinforced panels can leave the low density core exposed as these can be encapsulated within a joint that can provide a continuous connection from panel to panel where the connecting element provides protection against weather, fire, insects, etc. In one example, these exposed edges can be adhesively bonded or filled to connect them to the adjacent panel.

In various embodiments, cavities (e.g., filled with dense sub-dermal material) can permit any suitable shape to be excavated, depending on the milling, cutting or routing tool and the dexterity of the machine that operates it. The excavated cavity can correspond to the negative of the tool or tools profiles as they move through the material, such that, in various examples, the corners of some or all cavities can correspond to the radius of the tool spinning on its axis. The milled face in one example can mimic the profile of the element it is replacing, such as the inside of a junction box, or the interior space of the recess for a lighting fixture, with the milling profile held as close as possible to the form of the component it is replacing. The thickness of the reinforced infill material can vary, in one example being extremely thin (e.g., where it has no significant load carrying function) and in another example being quite thick or extending to the opposite structurally-reinforced skin (e.g., to attain strength and resilience as needed in that particular location). The exposed outer face and the hidden inner face need not be parallel, nor of the same shape, and in various embodiments it can be desirable for the reinforced filled cavity to attain sufficient performance as to permit the integrated composite panel to attain performance equivalent to or superior to that achieved by, for example, a junction box inserted into the cavity of a typical stud wall.

In some examples, such as at an electrical junction box or at a cavity that houses a light switch device, there may be need for a cover plate to hide and protect the wiring and connections. In these examples the reinforced infill material can be milled with a slight recess from the fiber-reinforced skin of the panel so that a cover plate can be fitted flush with the outer surface of the panel instead of fixing it outside the surface as is typically done with gypsum board and other wall surfaces that are not able to be precisely finished or pre-finished in various example. So, the integrated composite solution in various embodiments, availing itself of precise milling, cutting or routing, and with possibility of a high quality and resilient edge, can allow a higher quality than typical building methods that join prefabricated components on a building site.

In another example, where a pipe penetrates through a building element such as a wall or floor, the reinforced filler can be applied into a circular cavity that, when milled, can offer a precise diameter protective ring the full depth of the panel to (e.g., to protect the low density core material through which the pipe may pass). This can offer protection against water leakage (e.g., from condensation from the pipe), fire, insects, etc. to prevent damage to the core material.

In another example, a window frame can be formed by reinforced infill material into a full-depth cavity in the core material, with the inner profile of the frame cut, milled and/or routed to the profile needed or desired to house the glazed pane or frame of the window, or for other suitable purpose. In other words, in various embodiments, the reinforced infill can create a frame akin to a wooden frame of a traditional window but applied as an oversized block of material that adheres to the core prior to being excavated by cutting, milling and/or routing to the exact size and shape needed to accommodate the glazed elements of the window or to any other suitable or desirable size. The fiber-reinforced infill material in some examples can be formed by solid blocks or strips or by a liquid or semi-solid that solidifies to form a continuous frame that when cut, milled and/or routed creates a full window opening.

In another example, a cavity can be formed by milled, cut and/or routed reinforced infill material to house a light fitting or other device that might be recessed into the surface. The cavity in various embodiments can allow for tolerance and thermal venting as needed for that specific light fitting to allow the light or other device to be fitted with clips or gaskets or other positioning fixings. These few examples are indicative only as the needs in buildings are for many fixtures, fittings, recesses, etc. are virtually limitless. This subtractive-additive-subtractive method, combining composite materials with CAD-CAM, offer limitless potential to integrate any functional cavity. Accordingly, the illustrative examples discussed herein should not be construed as limiting on the wide variety of additional embodiments that are within the scope and spirit of the present disclosure.

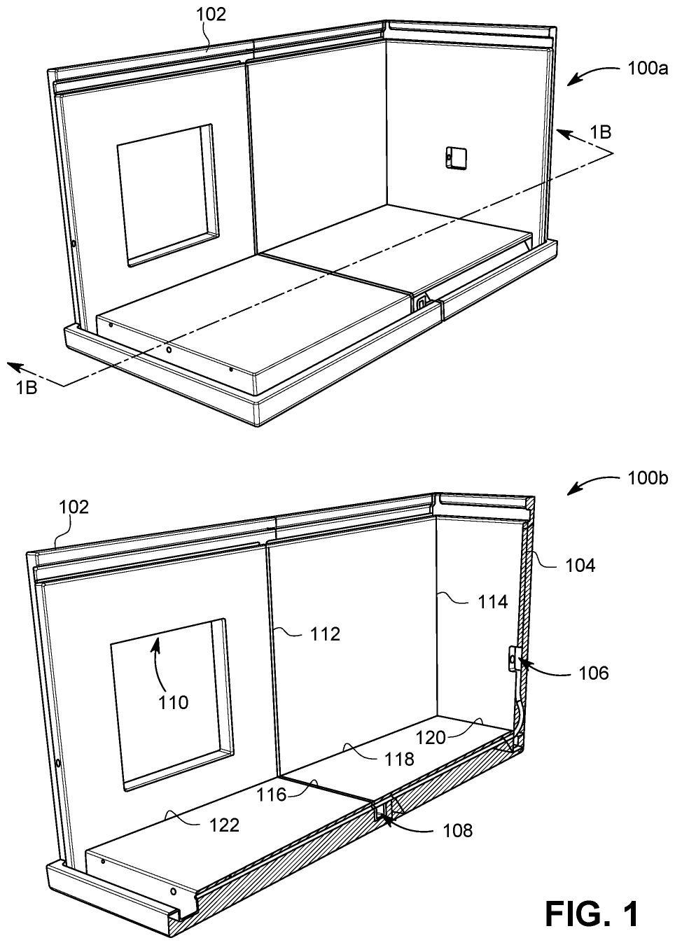

FIG. 1 illustrates a two views 100a and 100b of a five-panel planar structural composite building corner 102 with integrated sub-dermal electrical line and junction box 104, 106, plumbing/heating conduits 108, window frame 110, and panel joints 112-122.

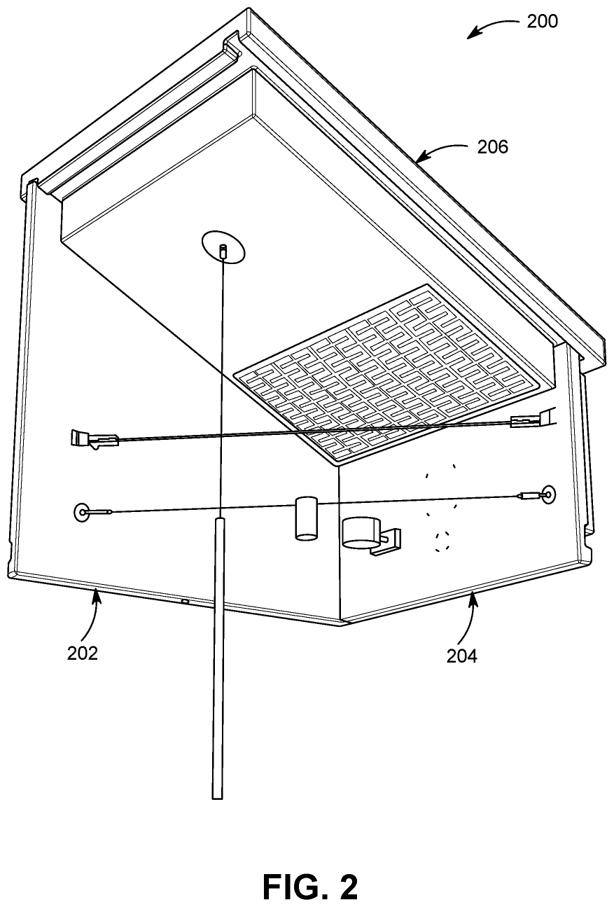

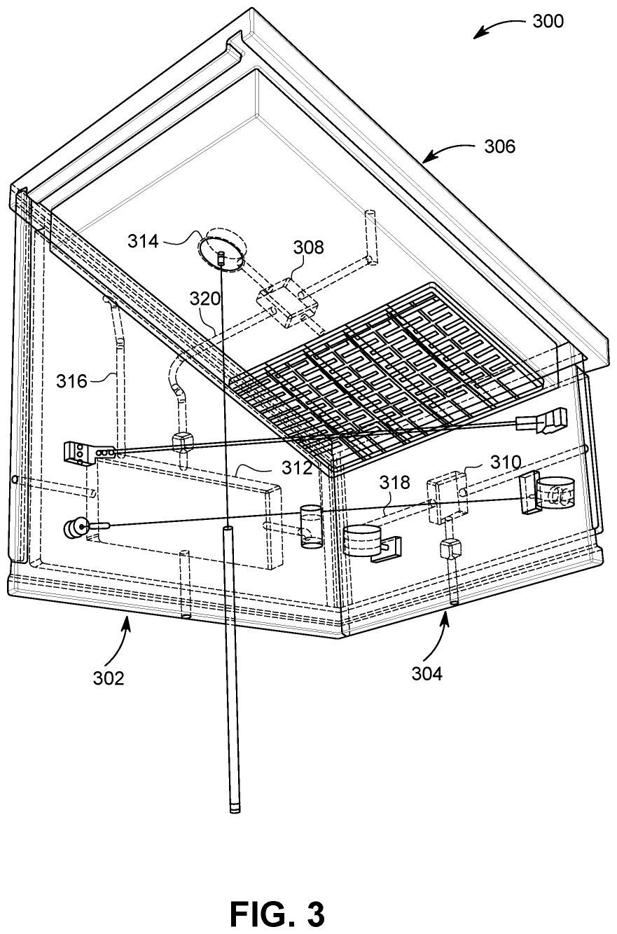

FIGS. 2-3 illustrate example views 200, 300 of three planar fiber-reinforced structural panels 202, 204, 206, 302, 304, 306 joined to form the corner of a building with integrated functional elements. Diagram 300 illustrates, via an x-ray view, various sub-dermal components embedded into the building panels 302, 304, 306, which may be formed by the techniques described herein. As illustrated, the sub-dermal components may include electrical junction boxes or cavities 308, 310, 312 cavities for light fixtures 314, and various electrical conduits 316-320 for running wire between the various electoral fixtures, to name a few of the possible electrical components that can be integrated into one or more building panels via the techniques described herein.

### Example Electrical and Plumbing Conduits

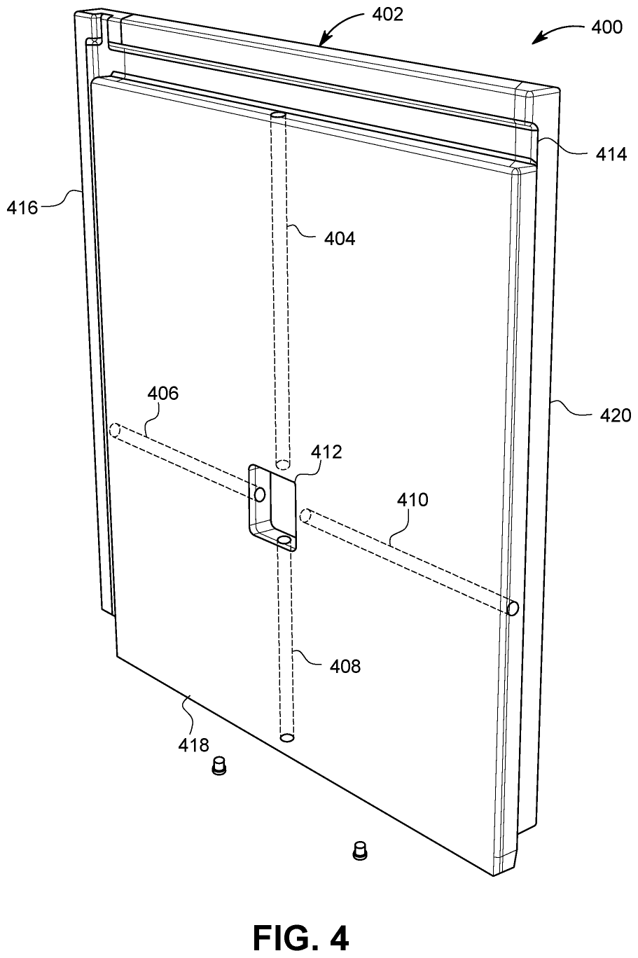

FIG. 4 illustrates an example 400 of a building panel 402 with excavated and fully encapsulated electrical conduits 404, 406, 408, 410 that connect to an electrical box or junction 412. In some aspects, the electrical conduits 404, 406, 408, 410 and electrical box or junction 412 may be formed via the excavation, fill, excavation techniques described herein. In some cases, one or more of edges 414, 416, 418, and 420 may be formed by a similar process.

In various embodiments of a structurally reinforced fiber panel building assembly, the ubiquity of the core material permits cavitation of functional elements such as electrical switches and junction boxes. But in some examples, an uninterrupted, skin-to-skin infill may limit or interfere with the usual incorporation of electrical conduits and pipes into the cavity of walls and floors. In various embodiments of the present technology, however, the subtraction of low density core by mechanical cutting, milling, routing or other methods can allow that conduit cavities and pipe chases can also be excavated. In one example, such linear tubular cavities can be created by a ball-end mill with fluted shaft such that a keyhole-shaped cavity can be established in the low density core. In another example a bull-nosed endmill excavates a U-shaped cavity in the low-density core. The round tubular cavity can, in various examples, allow for a pipe or tube to be placed or inserted into the core to give an uninterrupted pipe, tube or conduit for wiring or for gases or fluids to be contained within it.

To attain an (e.g., fully) encapsulated tubular conduit void in the low density sub-dermal core, in one example the panel may be comprised of an upper and a lower part, each with a semi-circular cavity milled into them such that when bonded together a coherent tubular void is formed, with some embodiments being entirely land-locked in the core panel. In another example, the void created by the shaft of the bull-nosed or ball-ended endmill can be filled with either an adhesively bonded sliver of core material that exactly matches or corresponds to the size of the slot, or by a liquid or semi-solid material that can expand by foaming into the void but that solidifies to completely fill it, trapping the conduit pipe as a land-locked void in the panel.

In some embodiments it can be desirable for such filler to closely match the structural, acoustical and thermal properties of that layer of the core material, such that a layer of high-compressive load carbon foam, for instance, is filled in with a similar compressive-load filler material. This filling of one or more surface cavitation can allow, in some embodiments, for full support for the fiber-reinforced skin when it is bonded to the filled core and/or can avoid any or some loss of load-carrying coherence in the core material.

Prior to the fiber-reinforced skin being attached to the core panel with filled conduit cavities, the panel face may be sanded or fly-milled to attain absolute or substantial flatness so that no or substantially no trace of the conduit lines is visible when the fiber-reinforced skin is bonded over the sub-dermal conduit cavity. In some cases, the sub-dermal pipes, tubes or conduits can occur at a depth to suit standard junction boxes whether they are installed as standard components or formed by excavation of the integrated sub-dermal mass.

Since the sub-dermal mass can provide insulation between inside and outside in external walls, in one example, the junction boxes can be sized with minimum depth, for example to avoid the risk of condensation at the back face of the junction box cavity due to the reduction of insulation thickness of the low density core material at that point. Similarly, since the acoustical and fire retardancy may be diminished where junction boxes occur, for example, where a layer of acoustical or fire retardant core has been milled away as well as the low density core, so the thickness of the filler material may compensate as far as possible for the missing material. In one example the filler material can be a higher density than the materials excavated from the cavity such that the overall mass and acoustical absorption is equal or substantially similar.

In some cases, insertion of conduit pipes into milled sub-dermal cavities can occur prior to the filling of voids or the cavities created for junction boxes, with pipes extending as continuously as possible in some examples, running across the milled cavities. When filling occurs, then the pipes can maintain a voided channel that latter cutting, milling, routing or other subtractive method can sever at the entrance and exit point of an edge of panel or junction box. The result in various examples can be to have a conduit pipe or tube (e.g., fully) encapsulated at one or both ends by a sub-dermal mass, offering a fully coherent barrier to water, fire, insects or other risks, and offering better coherence than typical multi-component site-installed systems.

Where the conduit cavity needs to turn a corner, such as in running from one panel to another panel in a multi-panel corner, in various embodiments, the minimum radius of the conduit pipe or tube can be formed as a looping linear tubular cavity that can allow the insertion of the pipe without it reaching its limit of curvature. In various examples, a given tube or pipe can have a different minimum radius of curvature, so the tubular cavity excavated can have a different radius for each different tube or pipe in some embodiments. In some cases. the inserted tube or pipe or conduit can be inserted as a single length, so that in some example later insertion of electrical wiring can be made easy by having fewer or no points where it might get snagged. Similarly, where fluid or gas pipes are inserted, joints within a given panel can be avoided in various embodiments to minimize the risk of leaks. In various embodiments it can be desirable for electrical conduit to not have more than three 90-degree internal corners for a given length as wires may snag with more than 270 degrees of angle change in some examples. The sub-dermal conduits and cavities in various embodiments may run vertically and/or horizontally or in any other suitable direction to suit the given or anticipated needs or desires in a specific panel or location or for other suitable purpose. In some cases, because standard joint elements may not be needed to install conduits, pipes, etc., other configurations, such as not dependent on 90 degree turns, may be utilized, such as to decrease the total amount of conduit material (either infill or tubes that may be inserted in the panels) needed.

Where conduit cavities cross and/or meet one another, and where it may be impossible or impractical or otherwise not desired to maintain a continuous pipe, tube or conduit, one or other of the conduit cavities can curve around the other one to permit continuity of both pipes, tubes or conduits. In such a case, the minimum radius of the given pipe, tube or conduit can establish the degree of curvature of the pathways of one or other conduit cavity. In some examples, horizontal conduit cavities can be less numerous than vertical cavities and so they will modify their path when they would otherwise cross a vertical conduit cavity.

At the edges of the fiber-reinforced composite panels where a conduit cavity and the pipe, tube or conduit that fills it may have been severed, in one example, a conical cavity can be excavated normal to the cross section of the pipe to taper the tube cavity outwards so that it gets slightly larger towards the edge of the panel, to form a port. This can be desirable in some examples to aid the pulling of wires across joints where the two conduit cavities in adjacent panels might not be perfectly aligned due to tolerances in the on-site installation process, or the like. By having conical voids at the ends of the tubular voids of the conduits, in various embodiments the ends of any wires can be deflected into the tubular cavity. In another example, a short tubular pipe can be sleeved around the ends of the tube, pipe or conduit and/or adhesively bonded so as to provide a thicker overall section at its ends, which in some examples can permit a bigger conical excavation than would be possible in the pipe alone. In another example, a cavity can be established in the sub-dermal core at the ends of all pipes, tubes or conduits, and then filled with a dense filler material that is later milled to create a cavity. This block of filler material can then be milled in the form of a conical cavity normal to the cross section of the pipe, for example to establish an even bigger funnel to guide wires as they are threaded between panels.

In one example, panel to panel connections between conduit cavities can be established between panels and across joints by inserting a short tubular section of pipe that maintains the internal cavity of the pipe unimpeded and continuous to avoid snagging where wires are pulled. Sub-dermal electrical conduit pipes may follow building codes and norms in various embodiments so that any repairs or remediation of the building can allow typical building trades and workers to avoid cutting or drilling into such electrical lines. For instance, conduit can in one example rise vertically to an electrical junction box, as is typical in current building practice.

Sub-dermal linear tubular cavities, lined internally with tube or pipe or conduit, may be established at a regular, irregular or patterned spacing horizontally and/or vertically throughout one or more given composite panel and/or through a building comprised of an assemblage of many composite panels. In one example these conduit cavities can be established every 3 ft throughout a building such that they are ready for use at any time, whether or not there are electrical wires installed initially. In one example wiring is pulled every 12 ft initially, leaving 3 conduit pipes or tubes empty for future use. The spacing of conduit cavities can be varied to any suitable dimension, and the number of conduit cavities can be increased or decreased to any suitable number, allowing conformity to building codes or norms or for other suitable purpose.

Sub-dermal blocks of filler may be established (e.g., at key points) in the core to permit future junction or electrical boxes or other elements to be installed at many points in a panel or building. These cavities in some examples can be filled with a dense sub-dermal filler that linear tubular conduit cavities can be excavated through, and pipes, tubes or conduits can be threaded through them. The fiber-reinforced skins can be bonded across the sub-dermal filler blocks such that they are available to be cut, milled or routed out to accommodate a new electrical fixture or fitting at that location. These sub-dermal blocks of filler can be established at any suitable frequency along conduit lines, in one example at 18″ above the floor, 36″ above the floor and 12″ below the ceiling. This in various embodiments offers a system and method to alter the electrical systems at a later date, which can benefit from a conduit infrastructure that can be established sub-dermally according to standard dimensions.

The inserted pipe, tube, conduit, may incorporate a metallic strip (e.g., facing the nearest fiber-reinforced skin), such that they can be easily located magnetically despite being buried sub-dermally. In some cases, the filler material that can close off a sub-dermal conduit cavity can have metallic particles of fine wires such that the conduit lines can be easily located magnetically despite being buried sub-dermally. In some cases, the filler material at junction box locations can have metallic particles or fine wires such that the conduit lines can be easily located magnetically despite being buried sub-dermally.

### Example Electrical Wiring

In some examples, the sub-dermal conduit cavities may be used to carry high voltage and/or low voltage wiring as required or desired in a given location in the building or for other suitable purpose. Where high voltage wiring is to be used, in various embodiments, it can be desirable to have protected junction boxes wherever high voltage wires are joined to other wires or to appliances, fixtures or fittings. In some embodiments, by filling a cavity in the sub-dermal core with dense reinforced filler material whose properties may be varied (e.g., to suit a given functional need such as offering fire retardancy at a junction box or for other suitable purpose), this building methodology offers systems and methods in various examples to excavate such sub-dermal filler material to provide an (e.g., fully) integrated and (e.g., fully) encapsulated junction box within the sub-dermal core material, where the filler material can be (e.g., fully) bonded to some or all adjacent materials, which can include the fiber-reinforced skin. In one example a typical manufactured plastic or metal junction box may be inserted into such cavity in the filler material. In another example, the filler material itself can be, comprise or define the junction box. Where the filler material is, comprises or defines the junction box, there can be an advantage in some examples in eliminating the need for a manufactured box and the labor associated with its installation.

Where high voltage wiring is used, in some embodiments, wires can be continuous from junction box to junction box according to building or electrical codes and norms, being pulled through conduit pipe, tube or conduit to cross between panels and be pulled around corners. If high-voltage wires are pre-installed in panels off-site, and in examples where they require joining to other wires at the panel joint, in various embodiments there can be a sub-dermal junction box at the panel joint.

If low-voltage wiring is used, in some embodiments, there may be no need for junction boxes where wires are joined, although junction boxes can still have practical value in many locations such as outlet points in various examples. Low voltage wiring may be installed in individual panels with connection-points provided where panels join to other panels, which in some examples can allow for the wiring to be joined by connecting the wires as the panels are installed.

### Example Sub-Dermal Heating

In various embodiments, excavating of linear tubular cavities into sub-dermal core material as described above can allow for continuous and variable-distribution of sub-dermal heating or cooling elements via insertion of continuous tubes or pipes that can carry water or another dynamic heat exchange medium. Some examples can include milling or routing circular or semi-circular cavities in one or more materials of the sub-dermal core, such that a tube can be inserted that can carry water or other liquids as a dynamic heat-transfer medium. The spacing size of such heating pipes or tubes and the radius of curvature of such cavities may be varied as needed or desired to suit pipe or tube and/or the functional needs for heating or cooling in that particular location or for other suitable purposes.

Inserting heating or cooling pipes can, in one example, involve continuous flexible tubing, such as plastic water piping, which in some embodiments can avoid leaking at joints which may be undesirable in a sub-dermal system. Said differently, in various embodiments, the system can allow for a single long pipe to snake back and forth sub-dermally through a composite panel, where this forms one closed loop back to a control manifold or other control element or fixture.

To allow insertion of a looping tubular water circuit, or a zig-zag arrangement to permit even distribution of heat into the panel, in one example, the tubes can be top-mounted into an open channel milled or routed into the core material, since linear insertion of the tube can become extremely difficult in some examples due to friction and change of direction. In such an example, the open U-shaped cavities can be filled with a thermally-conductive material that can allow the pipes to be maximally-conductive with the fiber-reinforced skin and/or an external finish that is applied to it. This filler may be sanded and/or fly-milled to establish it as flat and even prior to bonding the fiber-reinforced skin so its visual aspect is planar. In another example the channels for the heating/cooling pipes can be milled in a thermally conductive layer bonded to the low density core, for example carbon foam, such that in some example the entire layer or portion of the layer becomes warmer or cooler to offer an evenly distributed or more evenly distributed temperature to the surface of the panel. In yet another example, the heating/cooling pipes or tubes can be laid into semi-tubular cavities where an upper and lower layer traps the tube in a closed circular cavity. The upper milled material can comprise a thermally conductive layer such as carbon foam where the lower layer can comprise a thermally insulating layer such as the low-density core.

Sub-dermal heating/cooling conduits and pipes in some embodiments can be positioned to not cross electrical or other conduits by being at a different depth. Electrical conduits that are positioned to fit with existing junction box dimensions can in one example be deeper in the composite panel than the heating/cooling pipes, which in some embodiments it can be desirable to be in close proximity to the panel surface. Embodiments of such integrated composite technology can allow for different zones of the composite panel to be the (e.g., exclusive) domain of different systems such that, say, electrical and heating/cooling systems do not collide with one another or are generally separate.

Where heating/cooling pipes need to cross from panel to panel across a joint, in some embodiments the jointing device can be recessed into a milled cavity in a recessed sub-dermal cavity that permits access for maintenance. This can be by a cover plate recessed into the milled sub-dermal material such that its outer face is flush with the finish of the fiber reinforced skin or applied floor finish.

### Example RFID Tagging

In various embodiments, RFID tags may be added sub-dermally at a specified location, such as 18″ from the bottom and left inner face of any fiber-reinforced panel, placed and (e.g., adhesively) bonded in a cavity excavated in the low-density core material such that its outer surface is flat and co-planar with the sub-dermal core (e.g., after it has been sanded or fly-milled just prior to attaching the fiber-reinforced skin). The RFID tag may contain information about that specific panel such that it offers clarity as to the panel materials and geometries, including the sub-dermal filler materials and any conduit cavities (e.g., by storing data regarding or associated with such elements, or the like). This embedded information in various examples can allow for future modification of a panel, and/or to avoid cutting or drilling an existing conduit line or other sub-dermal element. Such an RFID tag in some embodiments can permit the panel to be re-manufactured in toto, for example with a modification to permit another arrangement such as a new wall attachment or window opening. In various embodiments a plurality of RFID tags associated with one or panels can store a collective set of data or information about a building assembly.

Since the fiber-reinforced panels are able to be manufactured by CAD-CAM methods in various embodiments, and to attain a high degree of dimensional accuracy given the low thermal expansion of composite panels due to the fiber-reinforced skins limiting any expansion and contraction, storing dimensional information in one or more RFID tag can be desirable in some examples over typical building methods where on-site fabrication might differ from construction drawings. RFID tagging of some or all panels can be desirable in various embodiments by embedding a (e.g., permanent) record of a set of information about that panel that can be used at various suitable times. In some examples, once a change has been made to a panel with an RFID tag, the RFID tag may be updated to reflect the modifications made to the panel. In this way, a complete history of any modifications made to a structure, may be accurately maintained and readily accessed. In this example, various ways of uploading the modification information may be supported, such as images, dimensional drawings, measurements, attributes of additional material inserted into the panel, and so on.

### Example Modification of Panels

Where there is need or desire to modify a panel, for example to add an electrical fixture such as a new light, in various embodiments, a site where sub-dermal filler material has been installed to allow for such new fixture or fitting can be excavated or routed together with the fiber-reinforced skin to provide a (e.g., protected) pocket with a conduit cavity to allow wiring to be run to it.

Locating one or more sites where sub-dermal filler material has been installed to allow for such new fixture or fitting can be achieved in some embodiments by reading an RFID tag or other suitable identifier (if one has been installed and can be located). In some embodiments, an internal element of a panel can be located by using a magnetic detector that locates a sub-dermal filler that has metallic particles or fibers, or elements distributed or otherwise disposed in it. Such features may be located by any other suitable method that senses the sub-dermal filler material or elements associated therewith, or by knowing the logic of the sub-dermal conduit cavities such as them being every 3 ft with junction box points 18″, 3 ft above the floor or 12″ below the ceiling (or any other known spacing).

Where there is need or desire to establish a new junction box where a sub-dermal filler material has not been provided, in various embodiments one or more conduit line can be located by any of the methods already mentioned or other suitable method. Then a cavity can be generated (e.g., routed by a straight-shaft router bit through the fiber-reinforced skin and into the sub-dermal core that in some examples is smaller than the eventual junction box). In some examples, a router bit with undercutting capability (or other suitable device) can then excavate from under the fiber-reinforced skin such that a filler material may be applied that attaches to one or both of the underside of the skin and the low-density core, with the filler being filled in some examples beyond the line of the first routed cavity, overlapping the edge. A straight-edge router bit or other suitable device can be used to rout the exact dimension of the junction box or at least a portion of the dimension of the junction box, for example by routing-away a little fiber-reinforced skin and filler material. The final result in various embodiments can attain a cavitated void in a sub-dermal filler that is (e.g., fully) bonded to one or both the low-density core and the fiber-reinforced skin, which in some examples can establish a strong, dense junction box as a (e.g., fully integrated) new element within the composite structural panel. In milling or otherwise generating the cavity, in various examples, the conduit pipe or tube can be severed flush with the internal faces of the junction box, fully bonded and integrated with it and forming a coherent and continuous cavitation for the electrical wiring.

The dimensions of one or more sub-dermal cavity can be varied, and in various embodiments need not involve an electrical connection: for example, a method of routing, undercutting, filling and/or re-routing can be applied to establish one or more cavities, which in various instance can offer a dense material that can replace a (e.g., low-density and vulnerable) core material that can otherwise be exposed in a cavitation. Examples of such ad hoc sub-dermal filler can be for fixing points for pictures or photographs or other decorative features, and in various examples these can be very small plugs of filler material that can offer a stable and resilient attachment point for a screw or hook or coupler.

### Example Two-Skin Structural Support

Where a high load is anticipated for instance on one or more panels, in some embodiments, it can be desirable for the sub-dermal filler to comprise fiber or bead reinforcement, and may benefit in some examples from bridging between, and (e.g., adhesively) bonding to, one or both fiber-reinforced skins on inside and outside of the composite structural panel. A benefit of attaching to both structural skins can be that a cantilevered load or pull-out load can be resisted by both skins acting in concert. Since the base structural principle of thin-skin composite panels in some embodiments can be that the separation of the two skins allows them to work like the flanges of a beam separated by a core material that acts like a low-density web, in various examples this offers a good moment resistance by adhesion to the two separated skins.

Where very high load is anticipated for instance, in some embodiments, it can be desirable for the sub-dermal filler to have a continuous fiber reinforcement such as a braided sleeve or woven fiber sheet inserted into the (e.g., milled) skin-to-skin cavity prior to the filler material being inserted, which in various examples can provide a fiber-reinforced column or fin of high-density filler in the low-density core. To enhance the effectiveness of such fiber reinforcement, in some embodiments, the braid or fiber-reinforced sheet can be extended under the fiber-reinforced skin for a prescribed distance to attain a structural load-transfer zone into the fiber-reinforced skin. This may be thought of in some examples as the capital of a column where load can be transferred from horizontal to vertical, or in some cases from the external fiber-reinforced skin of the panel to a vertical column or fin and then back out to the inner skin. Examples of where such high-load skin-to-skin fiber-reinforced infill may be desirable can include wall-mount toilets or large flat-screen televisions, or flag poles where wind load needs to be resisted, or brackets holding large plant pots or signage that may impose high eccentric loading.

In areas of extremely high load attached to walls for instance, in some embodiments, it can be desirable for the fiber-reinforced skins of the composite panel to include additional fiber reinforcement, for example where the sub-dermal core can be milled away to permit one or more additional layers of fiber-reinforced skin to be applied as patches, and in some examples stepping sequentially to smaller and smaller patches away from the fiber-reinforced skin into the low density core material. This layered fiber-reinforced internal “patching” may allow for a sub-dermal local reinforcement of one or more skins to distribute high load points into the thin-skin fiber-reinforced composite panels, so mitigating a high stress locally. Linking skin to skin in some examples can prevent one skin being eccentrically pulled off the core, where the low density core material might otherwise split away under tensile strain, for instance.

In various embodiments, a system and method of fiber-reinforced skin-to-skin sub-dermally-filled fixing points can permit highly specific and fully engineered connections as an integral part of a general composite structural panel methodology, and in some examples offering advantage over typical multi-material, multi-component building assembly, typical of industrial building methods that are pervasive in the current context. The advantage offered by integrated components and services in various embodiments of a composite panelized building system and method can be to be able to cater to many different attachment and load conditions within a now integrated new composite building methodology.

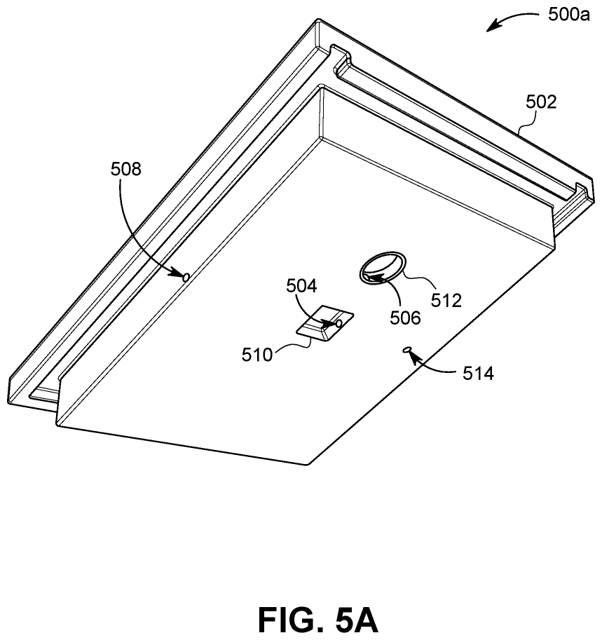

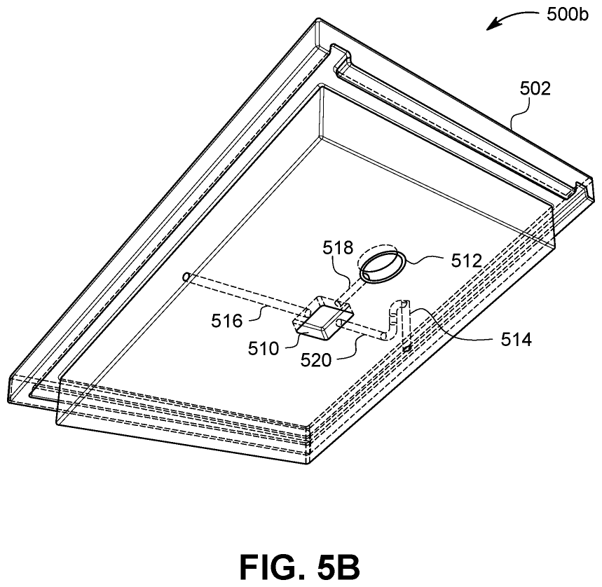

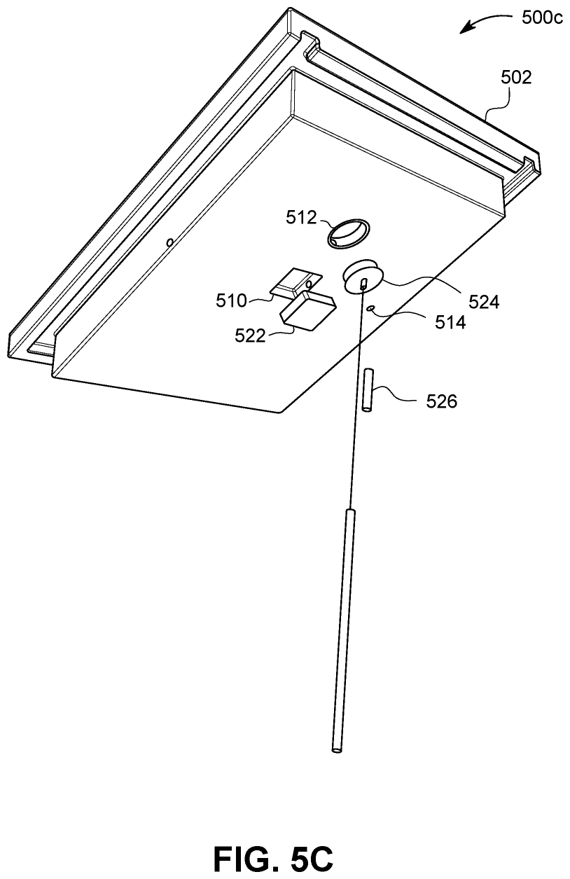

FIG. 5A illustrates an example diagram 500a of an outward aspect of an example composite structural roof panel 502 with entrances to excavated linear tubular conduit cavities 504, 506, 508, and excavated recesses for a junction box 510, a light transformer 512 and a tubular hole 514 for a recessed light.

FIG. 5B illustrates another example diagram 500b of roof panel 502, but with X-ray view showing the excavated and fully encapsulated conduits 516, 518, 520 in the sub-dermal core to link recessed electrical boxes 510, 512 and light fixture 514 to a minimum radius of the conduit pipe or tube.

FIG. 5C illustrates another example diagram 500c of roof panel 502, but showing the junction box 522, a transformer for a suspended light 524, and a tubular recessed spot light 526 prior to being inserted into the recessed cavities 510, 512, and 514.

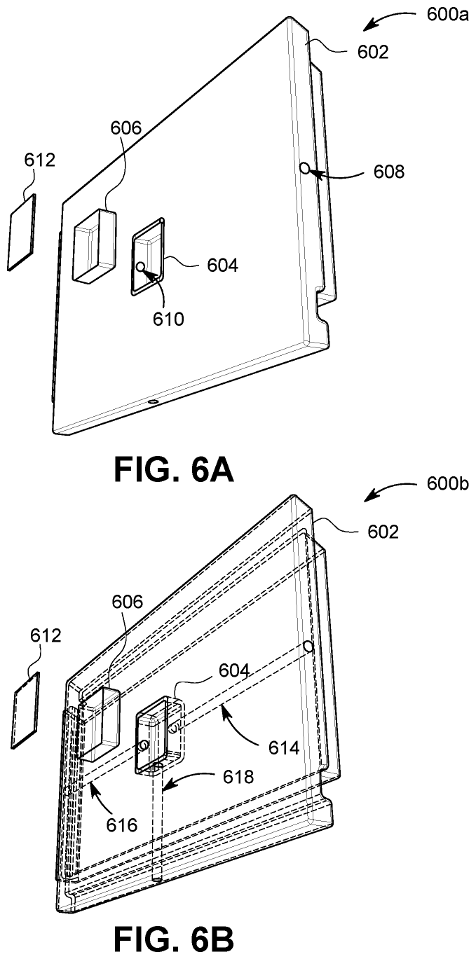

FIG. 6A illustrates an example diagram 600a of an external aspect of a composite structural wall panel 602 showing an excavated cavity 604 for a junction box 606 and over 612 with encapsulated sub-derma electrical conduits (illustrated in diagram 600 as holes 608, 610) ready for wiring.

FIG. 6B illustrates an example diagram 600b of composite structural wall panel 602, in X-Ray (e.g., indicate by dotted lines), showing the conduit tubes 614, 616, 618 encapsulated by low-density core material and with (e.g., high-density reinforced) filler milled to either itself form a junction box or to accept an inserted junction box.

### Example Manufacturing Process

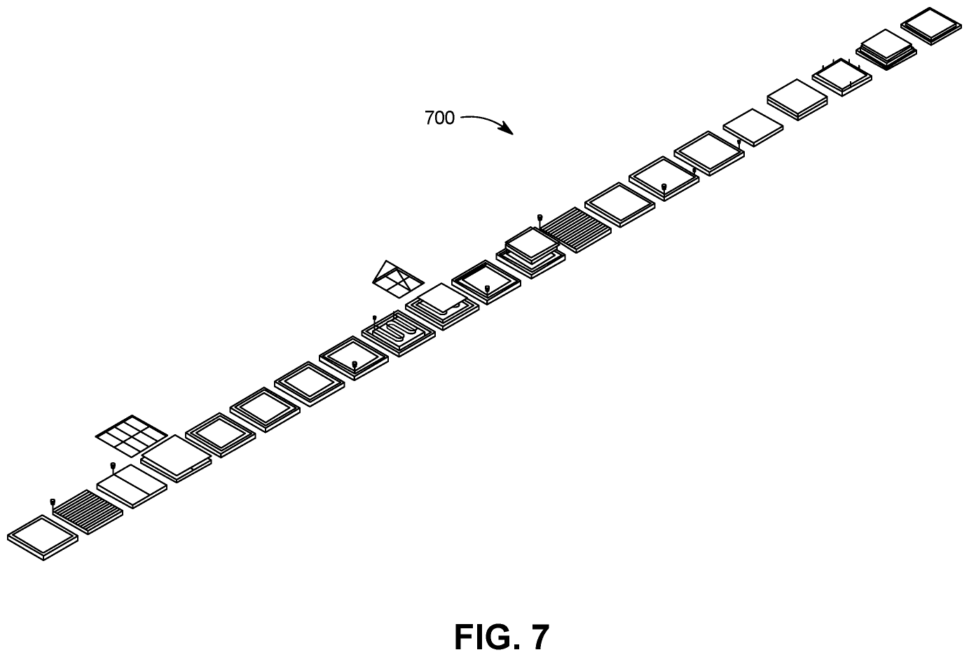

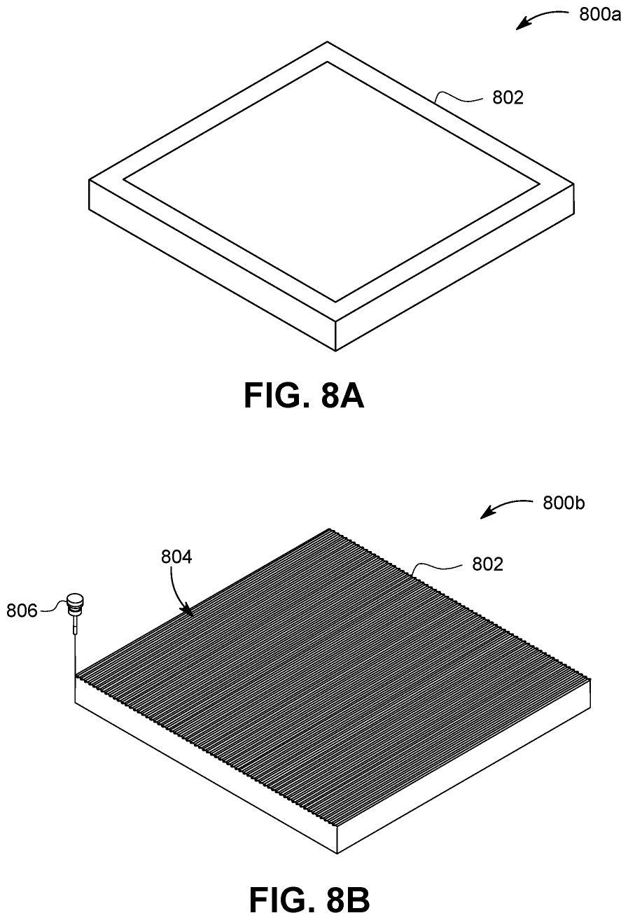

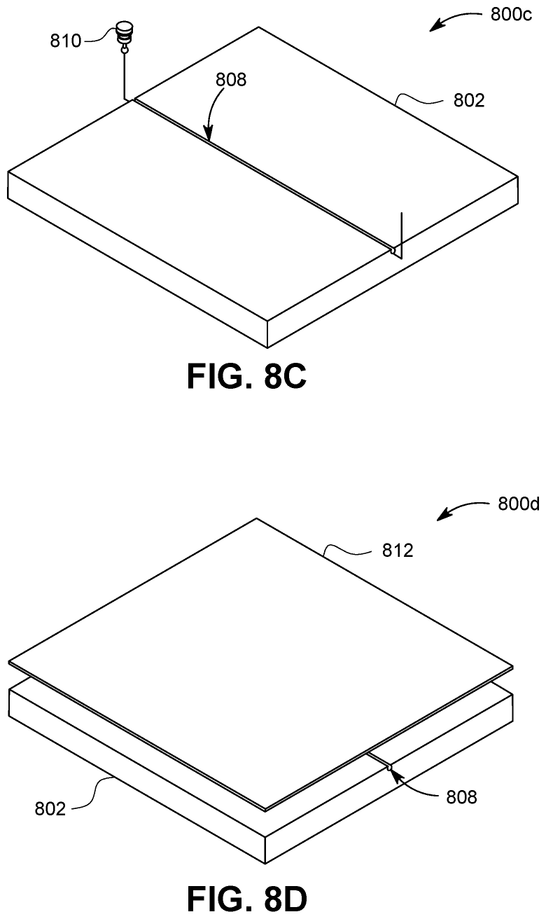

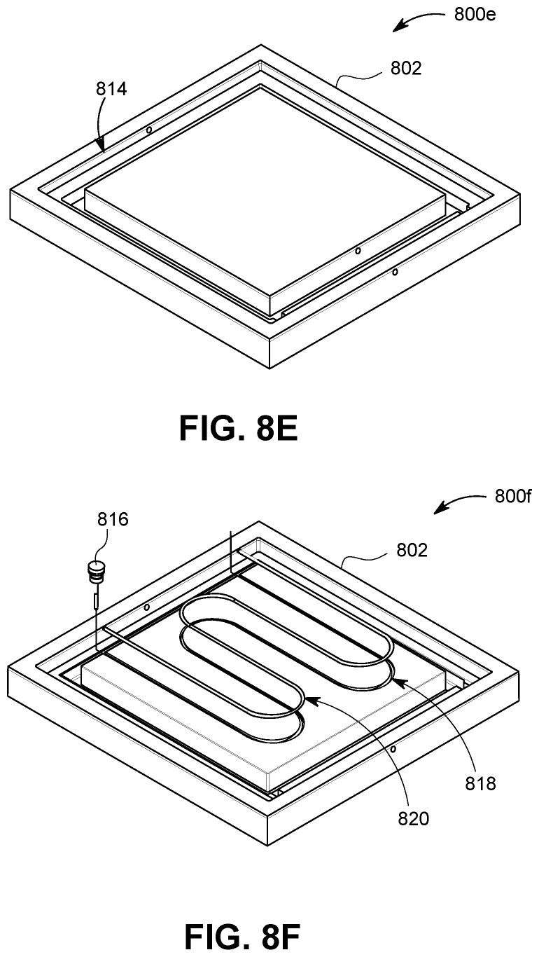

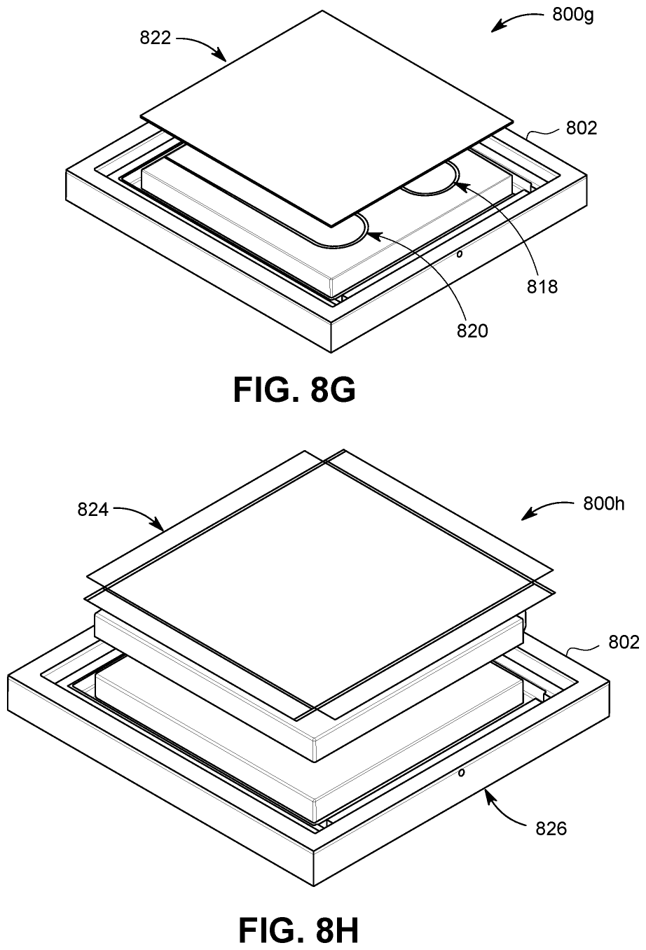

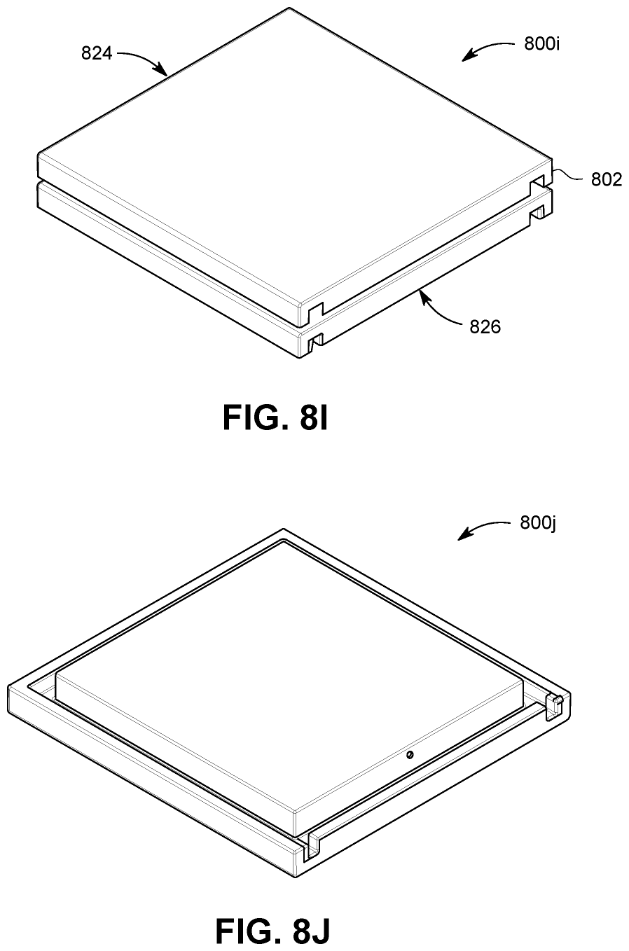

FIG. 7 illustrates an example diagram 700 of multiple manufacturing stages to produce a small floor panel with sub-dermal heating water piping & electrical conduits. The integrated components and services in in various embodiments of a composite panelized building system and method can be devised to permit step-by-step production that can allow fully automated or partially-automated production. By establishing a systematic logic for deploying dense and/or reinforced material into excavated cavities in a low-density core material, so sub-dermal functional conduits, chases, recesses, pockets, handles and other functional or decorative details can be incorporated as fully-integrated elements in large structural composite panels in accordance with some embodiments. FIGS. 7 and 8A-8J illustrate some examples of panel fabrication by such step-by-step methods but should not be construed as limiting. Diagram 700 shows an example of a small square composite panel with an interlocking geometric edge being fabricated to create fully integrated sub-dermal heating pipes and electrical wiring conduits, FIGS. 8A-8J illustrate many of these example manufacturing steps, as will be described in turn below. The mother board in some embodiments can contain many such panels to permit efficiency of multi-panel manufacture.

FIG. 8A illustrates an example view 800a of a low density planar core panel 802, which may slightly larger than the final panel is intended to be, allowing a buffer or dam of low-density core around edge cavities in the final panel.

FIG. 8B illustrates an example view 800b of panel 802 after it has been fly-milled or sanded flat to establish (e.g., absolute) flatness and dimension, as indicated by shading 804. In some cases, various tools, such as tool 806 may be utilized to establish one or more flat surfaces of panel 802.

FIG. 8C illustrates an example view 800c of panel 802 after a sub-dermal linear tubular cavity 808 has milled in the low-density core using a ball-end mill, bull-nose endmill or router (all indicated via tool, 810) into which an electrical conduit tube or pipe may be inserted.

FIG. 8D illustrates an example view 800d of panel 802 with a layer 812 of another core material is bonded to the low-density core panel 802 so as to cover the linear tubular sub-dermal cavity 808.

FIG. 8E illustrates an example view 800e of panel 802 with a sub-dermal cavity 814, forming a rectangle around an inside of the permitter of panel 802, milled to create a shaped interlocking edge, severing the sub-dermal electrical conduit pipe.

FIG. 8F illustrates an example view 800f of panel 802 with a bullnose-endmill 816 excavating a linear tubular zig zag cavity 818 into which a continuous flexible pipe or tube 820 is laid to carry heating or cooling fluids. In some cases, the ed of the pipe may be intentionally left long to aid to connecting the pipe to another panel, upon assembly, for example.

FIG. 8G illustrates an example view 800g of panel 802 with a finish sheet 822 bonded to the milled layer so as to cover the tubular cavity 818 and pipe 820, fully encapsulating it into a composite panel.

FIG. 8H illustrates an example view 800h of panel 802 with fiber-reinforced skins 824, 826 wrapped over top and bottom of the panel 802 to fully encapsulate the multi-material core to create a structural composite panel with sub-dermal heating and electrical conduits.

FIG. 8I illustrates an example view 800i of panel 802 with the composite skin 824, 826 wrapping over the full panel surface and all its edges.

FIG. 8J illustrates another example view 800j of panel 802: a planar structural composite panel with integrated sub-dermal heating/cooling and electrical conduits lined with continuous piping or tubing.

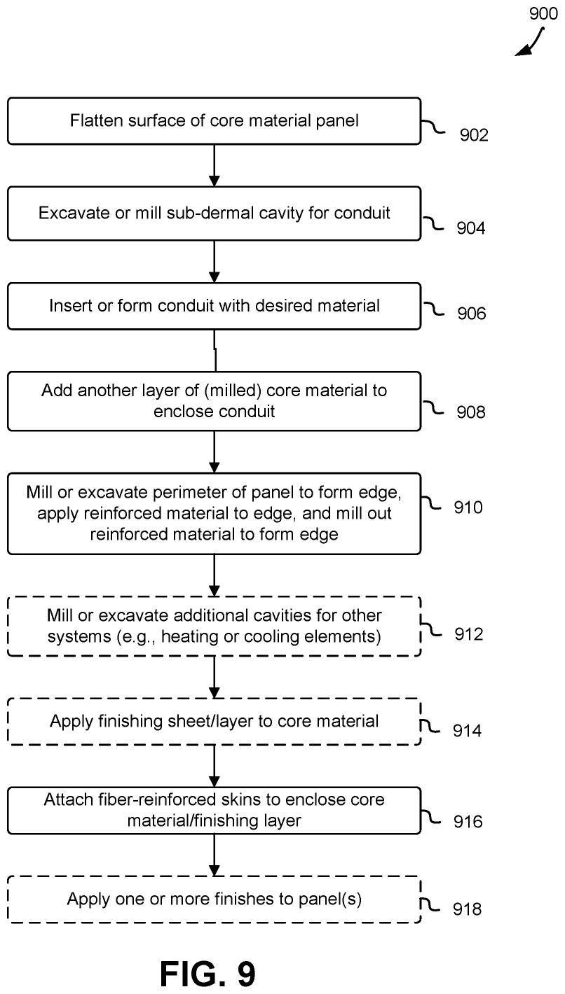

FIG. 9 illustrates an example process 900 for manufacture a building panel, such as the building panel illustrated in FIGS. 8A-8J, such as may include none or more of views 800a-800J of panel 802 described above. As used herein, dashed lines indicating a certain operation may signify that that operation is optional, such that process 900a may be performed with or without the so indicated operation(s).

In some examples, process 900 may begin at operation 902, in which a sheet of core material may be prepared for fabrication of one or more building panels, such as may include flattening one or more surfaces of the core material. Operation 902 may including cutting the sheet to a size usable by a milling or other machinery.

Next, at operation 904, one or more cavities may be milled or excavated for the placement of electrical conduits, electrical junction boxes, electrical fixtures, and so on, as described in greater detail above. As used herein, conduit may include or refer to all electrical (and/or heat, cooling or other elements) placed into building panels described herein, such as actual conduit or channel, junction boxes, transformers, fixtures that form a sub-dermal part of a panel, etc. Next, at operation 906, the excavated conduits may be filled with a suitable material, e.g., that may form the conduit itself. In some cases, this may include adding a paste or liquid material and then excavating the material to form the channel or conduit. In other cases, operation 906 may include inserting a pipe, conduit, or other externally formed element into the cavity, by various means. Next, at operation 908, another layer of core material may be added, such as on top of the core material containing the conduit. In some cases, the additional layer or sheet of core material may have been excavated and/or undergone operations 902, 904, and/or 906 prior to being bonded to the bottom core material layer.

Next, at operation 910, one or more areas or channels may be excavated from the upper face of the core material, where the excavated sections define boundaries of the or more panels. In some cases, portions of the core material may be excavated for other purposes, such as to add one or more different materials to the core material, to provide different attributes (e.g., insulating properties, fire retardant properties, acoustical properties, and the like). The excavated edge may then be filled with a reinforced (e.g., fiber-reinforced) material (e.g., liquid, semi-solid, or solid), and in some cases, excavated again to form the edge of one or more panels from the core material sheet.

In some optional cases, process 900 may additionally include operation 912, in which one or more additional cavities may be milled or excavated for other systems, such as for heating and/or cooling conduits. In yet some optional cases, one or more finishing layers or sheets may then be applied to one or both sides of the core material (e.g., to change properties of the core, add insulation, add fire retardant, acoustical properties, etc.), at operation 914. In some cases, operation 914 may include sanding, milling or another process to flatten one or both planar surfaces of the core material in preparation for the addition of skins. In various cases, one or more of operations 910, 912, 914 may be repeated for the other side of the core material. In some cases, processes may only need to be performed on one side of the core material, such as where only one slot is formed in the sub-dermal edge of a given panel, for use with a single planar joining element. In cases where two planar joining elements are used for a given edge of at least one of the panels to be extracted from the sheet of core material, then one or more of operations 910, 912, 914 may be performed for the other side of the core material sheet.

The skin elements (e.g., sheets of some type of fiber reinforced material), may then be attached to both sides of the core material, at operation 916. Edges may then be cut or milled (e.g., in one or multiple stages to cleanly cut skin and core materials, for example), to form one or more individual building panels from the larger sheet. In some optional cases, other details may be excavated from one or both planar surfaces (or any of the edges) of the resulting one or more panels. In some optional cases, one or more finishes, such as paint or coating material, thin veneer skin, such as wood or composite, may then be applied to one or both of the planar sides of the one or more panels (and/or edges) at operation 918. In some cases, one or more sub-dermal edges (e.g., slots or cavities as described above), may then be excavated, milled, or otherwise formed in one or more edges of the resulting panel(s), for example, where operation 910 does not result in a complete edge.

FIG. 10 illustrates an example diagram 1000 of multiple manufacturing stages to produce a large wall panel with window frame and sub-dermal heating water piping & electrical conduits. Diagram 1000 shows one example of a wall panel with different edge conditions and a sub-dermal electrical conduit being fabricated via a step-by-step process that may be automated or semi-automated or done by other suitable methods. The process can include excavating cavities that are filled with dense filler material that can be solid, semi-solid or liquid. When cured, the filler material in various embodiments can be made flat with the panel surface and (e.g., fiber-reinforced) skins bonded to the core, which in some examples can allow the sub-dermal filler material to be excavated to create functional pockets that protect the low-density core material. See drawings below for additional details and descriptions of this one example. The mother board in some embodiments can contain a suitable plurality of such panels to permit efficiency of multi-panel manufacture or for other suitable purpose.

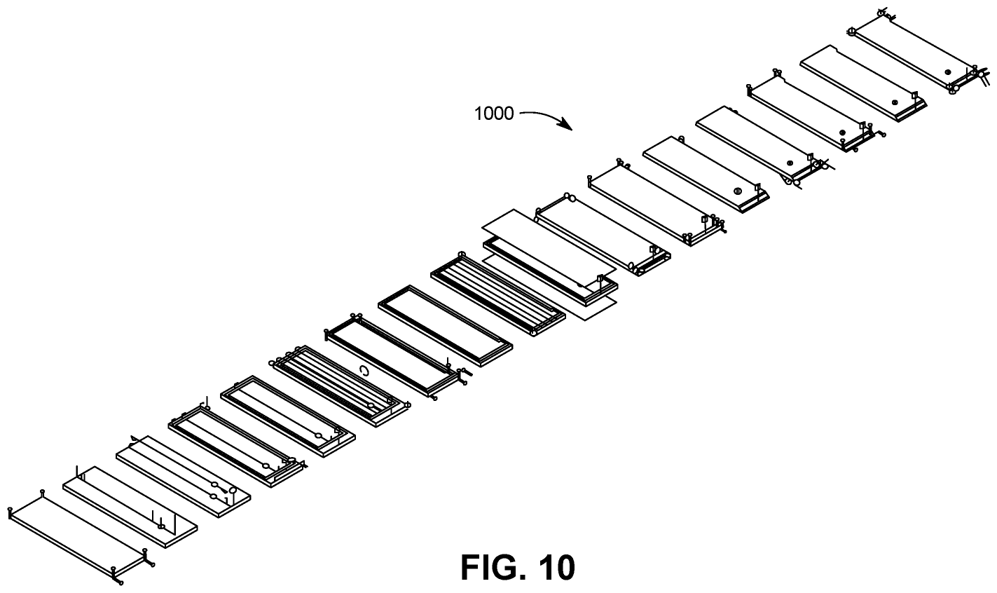

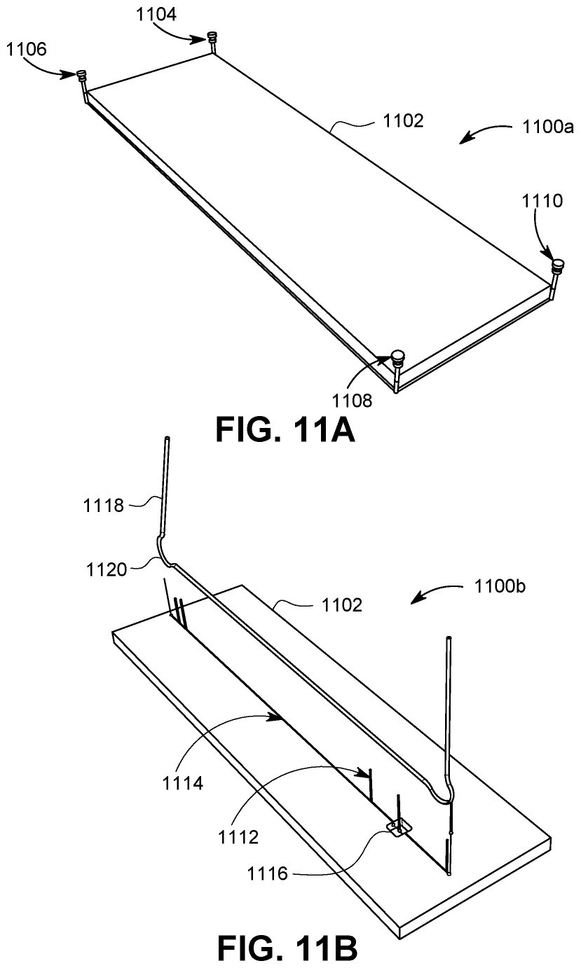

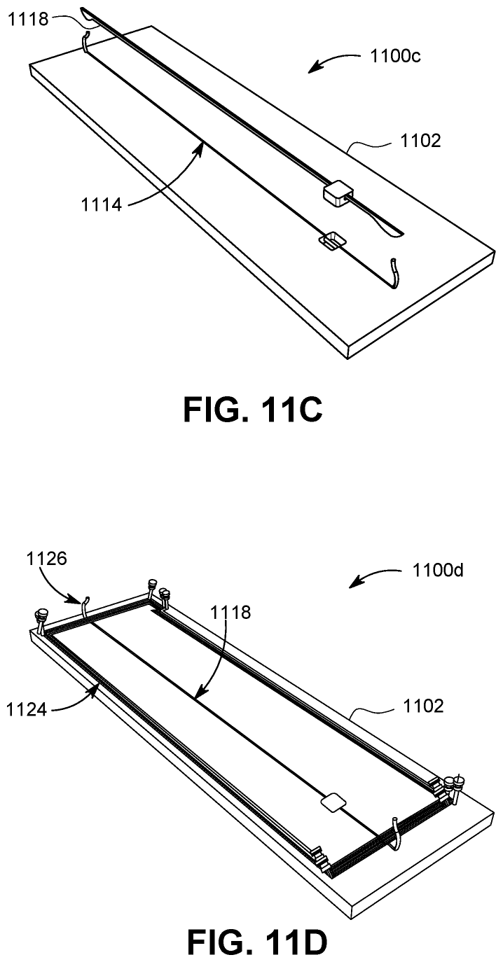

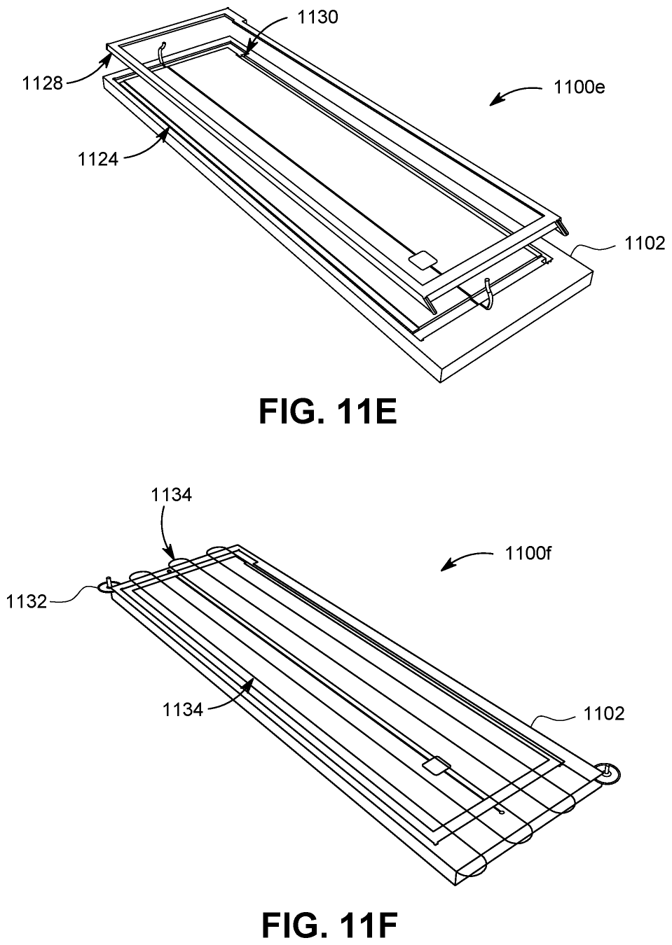

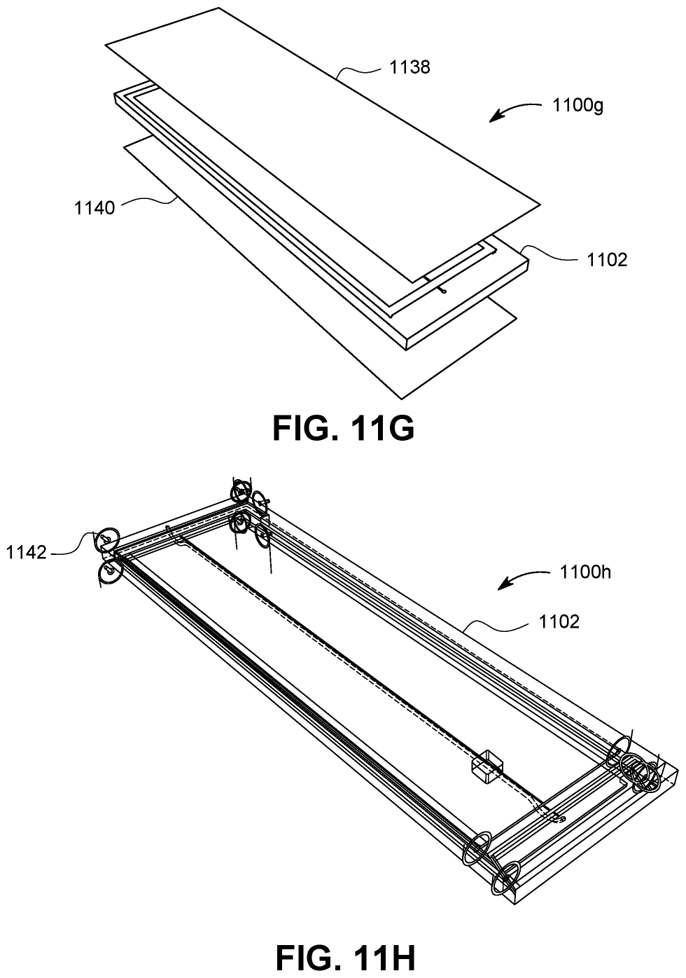

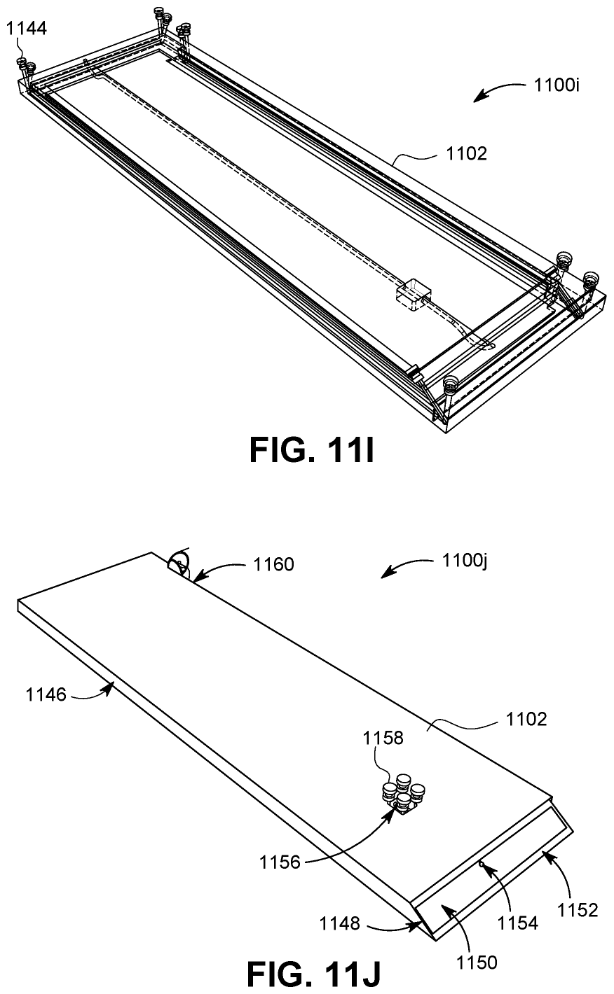

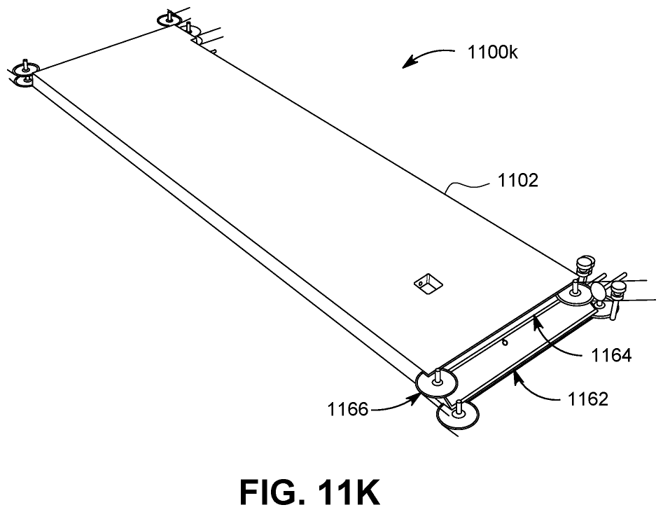

FIG. 11A illustrates an example view 1100a of an oversized panel 1102 of low-density core material, which in some embodiments can comprise, consist of or consist essentially of several different material layers according to functional need or desire or for other suitable purpose (e.g., carbon foam as a thermal and acoustical barrier bonded to a PET insulating core). Panel 1102 can be cut, milled, routed, sanded, or fly-milled to attain a (e.g., accurate) planar mother-board dimension, ready for manufacture. In this example, the panel 1102 is rectangular; however, it can be any planar polygon in further examples. In this example, the drawing shows a 2-layered panel 1102 and 4 positions 1104, 1106, 1108, 1110 of a single endmill performing surface trimming.

FIG. 11B illustrates an example view 1100b of panel 1102 with a ball-end mill (shown in drawing) or a bull-nosed endmill 1112 excavating linear tubular cavities or channels 1114 in the sub-dermal core, and slightly oversized sub-dermal cavities for junction boxes/switches 1116, as needed or desired or for other suitable purpose. Where the conduit 1118 changes directions 1120, a minimum radius curve can be excavated to permit that curvature, as shown in this example. Continuous flexible pipe or tubing can be laid in the linear tubular channel, extending across cavities and with ends extending from the panel 1102.

FIG. 11C illustrates an example view 1100c of panel 1102, where after inserting the flexible and continuous sub-dermal tubing, piping or conduit 1118 into cavities 1114, a filler material can be inserted to re-establish the panel 1102 as a coherent planar solid. In various embodiments, it can be desirable for infill material to attain structural coherence with the surrounding core materials, whether by adhesive bonding of a solid using a glue or through the solidification of a liquid infill, itself creating a bond to the core, or via other suitable method. This infill material may vary in its properties according to functional needs or desires at a specific location or for other suitable purpose, such as being resilient, mill-able and/or fire retardant at an electrical junction box location. It can be solid, liquid or a foaming material (e.g., to fully fill the cavities), and in some examples it be desirable for it to be of sufficient density to suit its ultimate function or other suitable purpose

FIG. 11D illustrates an example view 1100d of panel 1102 with conduit tube or pipe 1118 installed with filler material encapsulating it fully to re-establish a coherent rectangular low-density core mother board. Additional, slightly over-sized, cavities 1124 can be excavated as needed or desired for other functional requirements or for other suitable purposes. In the example illustrated, cavity 1124 is being milled for a sub-dermal structural edge. In some cases, the conduit pipe forms a loop 1126 at the panel edge so avoiding the edge cavity. View 1100d shows an endmill and tool path lines to excavate a variable-geometry edge according to the jointing arrangement needed or desired on that side. In some examples, the far side channel can be for a window frame, so the cavity can be milled deep to provide an encapsulated edge to the wall that integrates a window frame profile in subsequent manufacturing operations. Upper and lower surfaces can be excavated as needed or desired for the full panel to attain dense sub-dermal filler where needed or for other suitable purposes.

FIG. 11E illustrates an example view 1100e of panel 1102 with filler material 1128 being inserted into the excavated cavities 1124. The edges can all be different (or one or more can be the same), and the infill can vary down each edge depending on the functional needs in that specific location or for other suitable purpose. For example, in view 1100e of panel 1102, the far right-hand edge 1130 shows a change in detail as a window ends, and the near right edge is beveled, for example to be ready to meet an adjacent panel at 45-degrees to form a 90-degree panel-to-panel connection. The infill may use solids, liquids or semi-solids, and it may be a foaming material that expands to fully fill the cavity. In various examples the planar polygonal panel can be re-established as a coherent solid mass, fully bonded and integrated. Shrinkage of liquids or semi-solids can be mitigated in some embodiments by fiber or bead reinforcement.

FIG. 11F illustrates an example view 1100f of panel 1102 being fly-milled, sanded or otherwise re-finished to establish both upper and lower faces (e.g., absolutely) planer, which in some instance can make it ready for attachment of (e.g., fiber-reinforced) skins that can provide structural capacity to the multi-material core. In this example, a disc tool 1132 describes linear passes 1134 and circular turn-arounds 1136 along the zig zag path shown, but any suitable system or method can be employed to trim at least some excess filler and/or rectify at least some warping of the panels. Such operations can be applied to one or both faces, and in various instances taking care to maintain accurate thickness of the core panel and sub-dermal inserts and cavities. This operation can sever the sub-dermal conduit tubes or pipes at the surface of the core panel in some instances.

FIG. 11G illustrates an example view 1100g of panel 1102 with fiber-reinforced skins 1138, 1140 being bonded to both faces of the multi-material core of panel 1102 either using an adhesive and/or a pre-consolidated structural skin, or by the resin matrix of the fiber itself acting as a bonding matrix, or by another suitable method. In this example, both skins 1138, 1140 can be applied at the same time (e.g., to minimize warping as the resin or glue shrinks in curing), and both skins 1138, 1140 can be over-sized relative to the final building component (e.g., to permit accurate trimming-back to avoid errors in placement). The fiber-reinforced skins 1138, 1140 can be fully bonded across the full area of the core panel and to all multi-material areas (e.g., to ensure full composite integrity). In some embodiments, pressure and/or heat can be applied during bonding and/or curing of the skins (e.g., to ensure full adhesion).

FIG. 11H illustrates an example x-ray view 1100h of panel 1102 showing one example of (e.g., precisely) severing the fiber-reinforced structural skins 1138, 1140 using a diamond-encrusted disc tool 1142 such that the glass, carbon or other fibers are severed cleanly, as well as the solid dense sub-dermal insert which in some instances offers support to the cutting operation. Any appropriate cutting, milling or routing tool may be used, the goal of this operation in various instances being to establish clean accurate cuts through the (e.g., difficult-to-cut) fiber-reinforced skin, and accuracy of dimensions over the entire panel and all sub-dermal details. Some cuts can be non-orthogonal, such as where there is a 45-degree panel edge at a 90-degree panel-to-panel corner. This can be performed on one or both faces, and in some instances without moving the panel (e.g., so as to maintain accuracy by avoiding re-placement on a cutting table.)

FIG. 11I illustrates an example x-ray view 1100i of panel 1102 showing one example of a panel being severed fully using long endmills 1144 that can pass slightly outside the prior trimming edge (e.g., so the less high fidelity cutting of the endmill does not spoil the clean-cut edge). Any suitable tool can be used for this cutting operation that in some instances may be generally only severing low density core as the prior high-density sub-dermal infill material and the fiber-reinforced skins may have already been severed. This cutting operation may sever sub-dermal pipes, tubes or conduits at the face of the sub-dermal core. Note that some cuts can be non-orthogonal to establish the required or desired geometry in that particular location or for other suitable purpose. Some edges may have full-depth filler at openings or ends, where tool speed can be slowed down (e.g., to give appropriate quality of finish).

FIG. 11J illustrates another example view 1100j of panel 1102, a planar polygonal composite structural panel, trimmed and severed around its perimeter, with the near left face 1146 having full-depth encapsulation of the core by dense reinforced filler material, and the right near face 1148 having exposed low-density core 1150 between shallow pockets of dense reinforced sub-dermal material 1152 that also shows the severed end of the sub-dermal linear tubular conduit cavity 1154 lined with a continuous tube or pipe. This one example shows a junction box 1156 being excavated into the sub-dermal filler material with a diamond-encrusted endmill or router 1158 (shown in 4 positions as it excavates the full square volume). The far right edge or face 1160 is shown as an internal corner detail being cleanly trimmed to remediate the internal diameter of the endmill used for cutting.

FIG. 11K illustrates another example view 1100k of panel 1102 as structural slots 1162, 1164 are being excavated by using diamond-encrusted discs 1166. In some cases, the diamond-encrusted discs 1164 may apply a burring to all edges and faces of sub-dermal reinforced dense material and fiber-reinforced structural skins. Any appropriate tool can be used to attain a (e.g., highly accurate and high quality) finish to the fiber-reinforced structural panels, attaining in some embodiments (e.g., fully) integrated dense reinforced details that (e.g., fully) protect the low density core material, and in some examples, except at areas where the core will be entirely or partially hidden internally behind protective joints or joining elements. In one example, all core edges can be fully encapsulated to provide full protection against water, fire, insects, mold, etc. In another example, core material can remain exposed at edges where it can remain protected by joints between panels or other means.

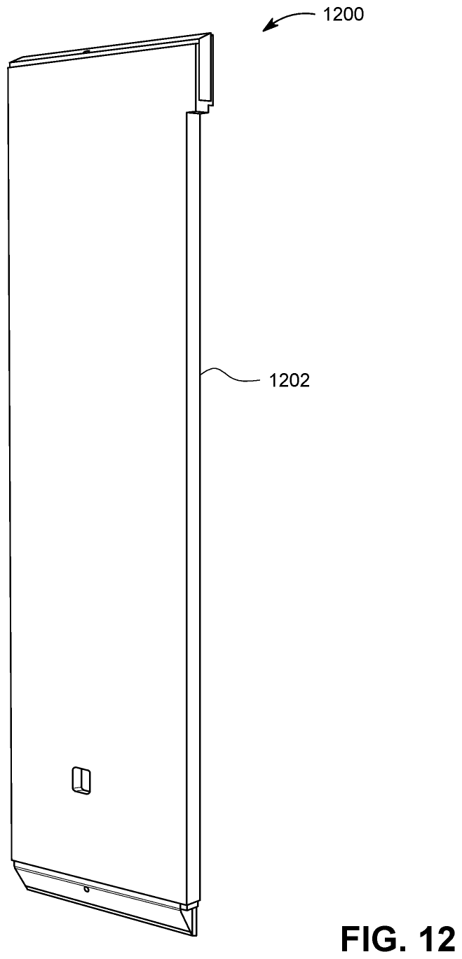

FIG. 12 illustrates a finished example 1200 of a building panel 1202, such as manufactured according to stages 11A-11J. An example of a finished composite structural wall panel with (e.g., fully) integrated components and services where the low-density insulating core material is (e.g., fully) protected by sub-dermal filler material excavated to provide a dense, resilient cavity to suit a particular function in a particular location or for other suitable purpose. The panels are able to be finished with any suitable external coating such as paint or veneer, the panel then joined to adjacent composite panels to create in some embodiments an all-composite building assembly from very few large-format parts to offer speed and economy of building installation.

Embodiments of the present disclosure can be described in view of the following clauses:
1. A composite building panel for use in a panelized structure, the composite building panel comprising:

a core, the core comprising a low density material defining at least one channel, wherein the at least one channel was formed in the core via subtractive manufacturing;

a utility conduit placed or formed in the at least one channel and bonded to the at least one channel and enclosed by the core, the utility conduit exiting the core along a first mating edge of the core or at a junction box excavated from the core;

a first fiber-reinforced skin element bonded to a first surface of the core and comprising a reinforced fibrous material;

a second fiber-reinforced skin element bonded to second surface of the core opposite the first surface forming a layered structure, the second reinforced skin element comprising the reinforced fibrous material, the layered structure comprising the first mating edge at an angle to the core and the first and the second reinforced skin elements; and

a reinforced block coupled to at least the first fiber-reinforced skin element and defining part of the first mating edge, the reinforced block comprising the reinforced fibrous material and defining a first portion of the first mating edge for mating with another composite building panel of the panelized structure.
2. The composite building panel of clause 1, wherein the utility conduit comprises an electrical conduit to run wire and at least one of a junction box or electrical fixture.
3. The composite building panel of clause 1 or 2, wherein the utility conduit comprises at least one of a heating or a cooling conduit.
4. The composite building panel of any of clauses 1-3, further comprising a thermally-conductive material placed or formed proximate to at least one of the heating or the cooling conduit and proximate to at least one of the first fiber-reinforced skin element or the second fiber-reinforced skin element.
5. The composite building panel of any of clauses 1-4, wherein the first mating edge further comprises a port to connect a second utility conduit of a second panel to the utility conduit of the composite building panel.
6. The composite building panel of any of clauses 1-5, wherein the port comprises a conical cavity in the first mating edge.
7. The composite building panel of any of clauses 1-6, wherein the core comprises a first core element defining a portion of the at least one channel and a second core element defining another portion of the at least one channel, wherein the first core element is bonded to the second core element to enclose the conduit in between the first core element and the second core element.
8. The composite building panel of any of clauses 1-7, wherein the at least one channel is formed by removing part of the core to form at least one cavity that is larger than the at least one channel, filling the at least one cavity with a reinforced material, and removing a portion of the reinforced material to at least partially define the conduit.
9. The composite building panel of any of clauses 1-8, wherein the at least one channel is formed by removing part of the core to form at least one cavity that is larger than the at least one channel, placing a conduit within the at least one cavity, applying a reinforced material proximate to the conduit, and removing a portion of the reinforced material to enclose the conduit within the core.
10 The composite building panel of any of clauses 1-9, wherein the at least one mating edge is formed by removing part of the core to form at least one cavity, filling the at least one cavity with a reinforced material, and removing a portion of the reinforced material to at least partially define the first portion of the first mating edge.
11. The composite building panel of any of clauses 1-10, wherein at least one additional portion of reinforced material is formed within the core to provide at least one of an anchor point for attaching at least one additional element to the composite building panel or a reinforced composite building panel with a higher load rating in at least one direction.
12. The composite building panel of any of clauses 1-11, wherein the conduit comprises a switch at a first location, and wherein the first fiber-reinforced skin element defines an opening for receiving a switch face plate that mounts flush to or not flush to the first fiber-reinforced skin element.
13. The composite building panel of any of clauses 1-12, further comprising at least one additional portion of reinforced material that is formed within or proximate to the core, and upon subtractive manufacturing, defines at least one of a door handle, or a drawer pull.
14. The composite building panel of any of clauses 1-13, wherein the core comprises at least one additional layer having increased insulation, fire retardant, or acoustical properties.
15. The composite building panel of any of clauses 1-14, wherein the conduit comprises a minimum bend radius to allow wires to be run within the conduit.
16. The composite building panel of any of clauses 1-15, further comprising at least one additional portion of reinforced material forming a second solid channel, wherein upon excavation, the second solid channel is dimensioned to house a second conduit.
17. The composite building panel of any of clauses 1-16, further comprising an RFID tag, the RFID tag comprising a mapping of the conduit within the composite building panel.
18. The composite building panel of any of clauses 1-17, wherein the reinforced block defines a slot, spanning substantially a width of the composite building panel, to receive a joining element for joining the composite building panel to another composite building panel, wherein upon receiving a load through slot via the joining element, the reinforced block distributes the load across the core and at least the first fiber-reinforced skin element.
19. A panelized building assembly, the assembly comprising:

a first composite building panel comprising a core material sandwiched between two first fiber-reinforced skin elements and having a first edge defining a first fiber-reinforced portion, the core material comprising a first utility conduit bonded to an enclosed by the core material, wherein the first edge defines a first access port to the first utility conduit;

a second composite building panel comprising the core material sandwiched between two second fiber-reinforced skin elements and having a second edge, the second edge defining a second fiber-reinforced portion, the core material comprising a second utility conduit bonded to and enclosed by the core material, wherein the second edge first defines a second access port to the second utility conduit; and

a joining element for use in coupling the first composite building panel to the second composite building panel such that the first fiber-reinforced portion and the second fiber-reinforced portion are in communication with one another, and wherein the first access port aligns with the second access port to form a combined conduit through the first composite building panel and the second composite building panel.
20. The panelized building assembly of clause 19, wherein the first and second utility conduits comprise an electrical conduit to run wire and at least one of a junction box or electrical fixture.
21. The panelized building assembly of clause 19 or 20, wherein the first and second utility conduits comprise at least one of a heating or a cooling conduit.
22. The panelized building assembly of clause 21, further comprising a thermally-conductive material placed or formed proximate to at least one of the first and second heating or the cooling conduits and proximate to at least one of the first fiber-reinforced skin elements or the second fiber-reinforced skin elements.
23. The panelized building assembly of any of clauses 19-22, wherein at least one of the first access port or the second access port comprise a conical cavity in the first edge or the second edge.
24. The panelized building assembly of any of clauses 19-23, wherein the first utility conduit and the second utility conduit are formed by removing part of the core to form at least one cavity that is larger than the first utility conduit and the second utility conduit, filling the at least one cavity with a reinforced material, and removing a portion of the reinforced material to at least partially define the first utility conduit and the second utility conduit
25. The panelized building assembly of any of clauses 19-24, wherein the first utility conduit and the second utility conduit are formed by removing part of the core to form at least one cavity that is larger than the first utility conduit and the second utility conduit, placing a first conduit and a second conduit within the at least one cavity, applying a reinforced material proximate to the first and second conduits, and removing a portion of the reinforced material to enclose the first and second conduits within the core.
26. The panelized building assembly of any of clauses 19-25, wherein the first edge and the second edge are formed by removing part of the core to form at least one cavity, filling the at least one cavity with a reinforced material, and removing a portion of the reinforced material to at least partially define the first edge and the second edge.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

What is claimed is:

1. A composite building panel for use in a panelized structure, the composite building panel comprising:
a core, the core comprising a low density material defining at least one channel, wherein the at least one channel was formed in the core via subtractive manufacturing;
a utility conduit placed or formed in the at least one channel and bonded to the at least one channel and enclosed by the core, the utility conduit exiting the core along a first mating edge of the core or at a junction box excavated from the core;
a first fiber-reinforced skin element bonded to a first surface of the core and comprising a reinforced fibrous material;
a second fiber-reinforced skin element bonded to second surface of the core opposite the first surface forming a layered structure, the second reinforced skin element comprising the reinforced fibrous material, the layered structure comprising the first mating edge at an angle to the core and the first and the second reinforced skin elements; and
a reinforced block coupled to at least the first fiber-reinforced skin element and defining part of the first mating edge, the reinforced block comprising the reinforced fibrous material and defining a first portion of the first mating edge for mating with another composite building panel of the panelized structure.

2. The composite building panel of claim 1, wherein the utility conduit comprises an electrical conduit to run wire and at least one of a junction box or electrical fixture.

3. The composite building panel of claim 1, wherein the utility conduit comprises at least one of a heating or a cooling conduit.

4. The composite building panel of claim 1, further comprising a thermally-conductive material placed or formed proximate to at least one of the heating or the cooling conduit and proximate to at least one of the first fiber-reinforced skin element or the second fiber-reinforced skin element.

5. The composite building panel of claim 1, wherein the first mating edge further comprises a port to connect a second utility conduit of a second panel to the utility conduit of the composite building panel.

6. The composite building panel of claim 1, wherein the port comprises a conical cavity in the first mating edge.

7. The composite building panel of claim 1, wherein the core comprises a first core element defining a portion of the at least one channel and a second core element defining another portion of the at least one channel, wherein the first core element is bonded to the second core element to enclose the conduit in between the first core element and the second core element.

8. The composite building panel of claim 1, wherein the at least one channel is formed by removing part of the core to form at least one cavity that is larger than the at least one channel, filling the at least one cavity with a reinforced material, and removing a portion of the reinforced material to at least partially define the conduit.

9. The composite building panel of claim 1, wherein the at least one channel is formed by removing part of the core to form at least one cavity that is larger than the at least one channel, placing a conduit within the at least one cavity, applying a reinforced material proximate to the conduit, and removing a portion of the reinforced material to enclose the conduit within the core.

10. The composite building panel of claim 1, wherein the at least one mating edge is formed by removing part of the core to form at least one cavity, filling the at least one cavity with a reinforced material, and removing a portion of the reinforced material to at least partially define the first portion of the first mating edge.

11. The composite building panel of claim 1, wherein at least one additional portion of reinforced material is formed within the core to provide at least one of an anchor point for attaching at least one additional element to the composite building panel or a reinforced composite building panel with a higher load rating in at least one direction.

12. The composite building panel of claim 1, wherein the conduit comprises a switch at a first location, and wherein the first fiber-reinforced skin element defines an opening for receiving a switch face plate that mounts flush to or not flush to the first fiber-reinforced skin element.

13. The composite building panel of claim 1, further comprising at least one additional portion of reinforced material that is formed within or proximate to the core, and upon subtractive manufacturing, defines at least one of a door handle, or a drawer pull.

14. The composite building panel of claim 1, wherein the core comprises at least one additional layer having increased insulation, fire retardant, or acoustical properties.

15. The composite building panel of claim 1, wherein the conduit comprises a minimum bend radius to allow wires to be run within the conduit.

16. The composite building panel of claim 1, further comprising at least one additional portion of reinforced material forming a second solid channel, wherein upon excavation, the second solid channel is dimensioned to house a second conduit.

17. The composite building panel of claim 1, further comprising an RFID tag, the RFID tag comprising a mapping of the conduit within the composite building panel.

18. The composite building panel of claim 1, wherein the reinforced block defines a slot, spanning substantially a width of the composite building panel, to receive a joining element for joining the composite building panel to another composite building panel, wherein upon receiving a load through slot via the joining element, the reinforced block distributes the load across the core and at least the first fiber-reinforced skin element.

19. A panelized building assembly, the assembly comprising:
a first composite building panel comprising a core material sandwiched between two first fiber-reinforced skin elements and having a first edge defining a first fiber-reinforced portion, the core material comprising a first utility conduit bonded to an enclosed by the core material, wherein the first edge defines a first access port to the first utility conduit;
a second composite building panel comprising the core material sandwiched between two second fiber-reinforced skin elements and having a second edge, the second edge defining a second fiber-reinforced portion, the core material comprising a second utility conduit bonded to and enclosed by the core material, wherein the second edge first defines a second access port to the second utility conduit; and
a joining element for use in coupling the first composite building panel to the second composite building panel such that the first fiber-reinforced portion and the second fiber-reinforced portion are in communication with one another, and wherein the first access port aligns with the second access port to form a combined conduit through the first composite building panel and the second composite building panel.

20. The panelized building assembly of claim 19, wherein the first and second utility conduits comprise an electrical conduit to run wire and at least one of a junction box or electrical fixture.

21. The panelized building assembly of claim 19, wherein the first and second utility conduits comprise at least one of a heating or a cooling conduit.

22. The panelized building assembly of claim 21, further comprising a thermally-conductive material placed or formed proximate to at least one of the first and second heating or the cooling conduits and proximate to at least one of the first fiber-reinforced skin elements or the second fiber-reinforced skin elements.

23. The panelized building assembly of claim 19, wherein at least one of the first access port or the second access port comprise a conical cavity in the first edge or the second edge.

24. The panelized building assembly of claim 19, wherein the first utility conduit and the second utility conduit are formed by removing part of the core to form at least one cavity that is larger than the first utility conduit and the second utility conduit, filling the at least one cavity with a reinforced material, and removing a portion of the reinforced material to at least partially define the first utility conduit and the second utility conduit

25. The panelized building assembly of claim 19, wherein the first utility conduit and the second utility conduit are formed by removing part of the core to form at least one cavity that is larger than the first utility conduit and the second utility conduit, placing a first conduit and a second conduit within the at least one cavity, applying a reinforced material proximate to the first and second conduits, and removing a portion of the reinforced material to enclose the first and second conduits within the core.

26. The panelized building assembly of claim 19, wherein the first edge and the second edge are formed by removing part of the core to form at least one cavity, filling the at least one cavity with a reinforced material, and removing a portion of the reinforced material to at least partially define the first edge and the second edge.
